(19) United States
(12) Patent Application Publication
(10) Pub. No.: US 2026/0081965 A1
(43) Pub. Date: Mar. 19, 2026

(54) SYSTEMS AND METHODS FOR APPLICATION PROGRAMMING INTERFACES ASSOCIATED WITH CLOUD SERVICES

(71) Applicant: Verizon Patent and Licensing Inc., Basking Ridge, NJ (US)

(72) Inventor: Mehmet TOY, Allendale, NJ (US)

(73) Assignee: Verizon Patent and Licensing Inc., Basking Ridge, NJ (US)

(21) Appl. No.: 18/889,502

(22) Filed: Sep. 19, 2024

(51) Int. Cl. H04L 67/02; H04L 43/0811; H04L 67/10

(52) U.S. Cl. CPC H04L 67/02; H04L 43/0811; H04L 67/10

(57) ABSTRACT

In some implementations, a device may identify a set of application programming interfaces (APIs) associated with a type of cloud service. The device may identify a set of APIs associated with a connectivity type. The device may identify a set of APIs associated with overlay components. The device may connect to one or more entities associated with a cloud service based on the set of APIs associated with the type of cloud service, the set of APIs associated with the connectivity type, and the set of APIs associated with the overlay components.

### BACKGROUND

Cloud services may offer scalable resources like storage, computing power, networking, and various applications, which users may access and use remotely. Cloud services may be provided by cloud service providers, which may use data centers to house physical infrastructure required to deliver the cloud services. Cloud services may be built on a range of components that work together to provide computing, storage, private networking, and/or networking over the Internet. Such components may be connected via wired and/or wireless connections.

### BRIEF DESCRIPTION OF THE DRAWINGS

FIG. 1 is a diagram of an example associated with application programming interfaces (APIs) associated with cloud services.

FIG. 2 is a diagram of an example associated with Metro Ethernet Forum (MEF) standard interfaces for APIs.

FIG. 3 is a diagram of an example associated with a MEF API structure.

FIG. 4 is a diagram of an example associated with a cloud services architecture.

FIG. 5 is a diagram of an example associated with a cloud services architecture.

FIG. 6 is a diagram of an example associated with a cloud service architecture.

FIG. 7 is a diagram of an example associated with a cloud service model.

FIG. 8 is a diagram of an example associated with a cloud service model.

FIG. 9 is a diagram of an example associated with a mesh network.

FIG. 10 is a diagram of an example associated with a mesh network.

FIG. 11 is a diagram of an example associated with a mesh network.

FIG. 12 is a diagram of an example associated with a cloud service topology.

FIG. 13 is a diagram of an example associated with a cloud service topology.

FIG. 14 is a diagram of an example associated with a cloud service topology.

FIG. 15 is a diagram of an example associated with a cloud service topology.

FIG. 16 is a diagram of an example associated with an API hierarchy.

FIG. 17 is a diagram of an example associated with a monitor-and-notify managed service.

FIG. 18 is a diagram of an example associated with a co-managed managed service.

FIG. 19 is a diagram of an example associated with a fully-managed managed service.

FIG. 20 is a diagram of an example associated with a private Internet Protocol (IP) (PIP) API.

FIG. 21 is a diagram of an example associated with a software cloud interconnect (SCI) API.

FIG. 22 is a diagram of an example associated with a software defined interconnect (SDI) API.

FIG. 23 is a diagram of an example associated with a mesh network API.

FIG. 24 is a diagram of an example associated with a customer edge (CE) API.

FIG. 25 is a diagram of an example associated with a load balancer (LB) API or a global load balancer (GLB) API.

FIG. 26 is a diagram of an example associated with a regional edge (RE) connectivity API.

FIG. 27 is a diagram of an example associated with a relationship between operational APIs and payload APIs.

FIG. 28 is a diagram of an example associated with an SCI architecture.

FIG. 29 is a diagram of an example associated with an SCI architecture.

FIG. 30 is a diagram of an example associated with an SDI architecture for a layer 2 (L2) transport.

FIG. 31 is a diagram of an example associated with an SDI architecture for an L2 transport.

FIG. 32 is a diagram of an example associated with an SDI architecture for a layer 3 (L3) transport.

FIG. 33 is a diagram of an example associated with an SDI architecture for an L3 transport.

FIG. 34 is a diagram of an example associated with an SDI architecture for an L2 transport.

FIG. 35 is a diagram of an example environment in which systems and/or methods described herein may be implemented.

FIG. 36 is a diagram of example components of one or more devices of FIG. 33.

FIG. 37 is a flowchart of an example process associated with APIs associated with cloud services.

### DETAILED DESCRIPTION OF EXAMPLE EMBODIMENTS

The following detailed description of example implementations refers to the accompanying drawings. The same reference numbers in different drawings may identify the same or similar elements.

An API may be a set of rules and protocols (e.g., Representational State Transfer Protocol—REST Protocol) that allow for different entities to communicate with each other and share data or functionality. The entities may include software and/or computing devices. The API may define a manner in which requests are transmitted between the entities and a manner in which responses should be formatted. The API may define functions such as service qualifications, quoting, and ordering; dynamic service modifications; fault, performance, and security management, or data that is to be available. The API may define a usage of the data. APIs may allow different systems and applications to function together without manual interventions. APIs may provide access to data or services that would otherwise be difficult to obtain. APIs may enable extracting and sharing data within and across environments. APIs are the key components of networks and service automation.

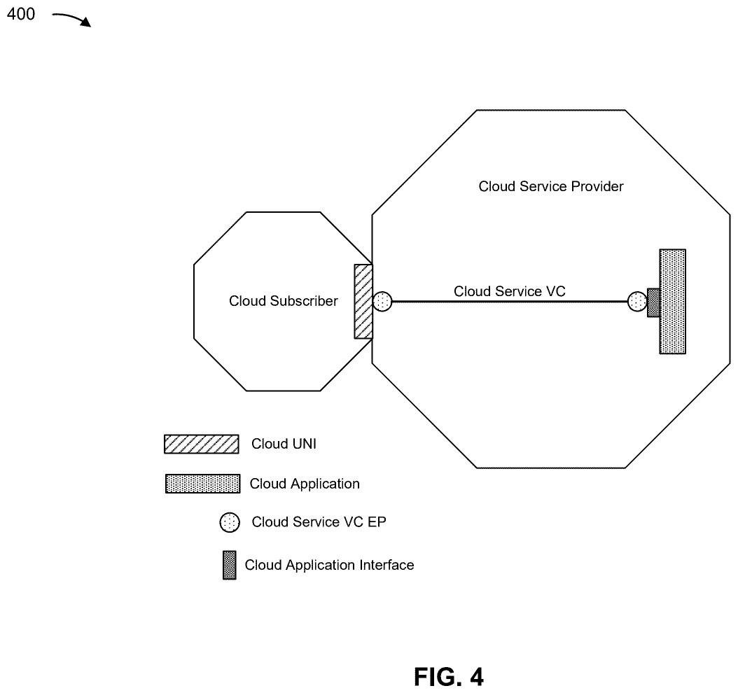

A cloud environment may be a virtual space that provides computing resources and services over the Internet and/or private networks. Organizations and users may leverage cloud environments to store data, run applications, and perform various computing tasks, instead of relying on local servers or personal computers. Cloud environments may be managed and provided by cloud operators. A cloud environment may include a public cloud, which may be operated by a cloud operator or a private cloud dedicated to cloud service customers. Resources, such as servers and storage, may be dedicated to and managed by the cloud service provider (e.g., as shown in FIGS. 4-8) and shared among multiple users of the cloud service provider. A cloud environment may include a private cloud, which may be a dedicated infrastructure for a single organization in a shared public cloud environment, on-premises or by a third-party provider. A private cloud may provide more control, security, and customization as compared to a public cloud. A cloud environment may include a hybrid cloud, which may combine public and private cloud environments, allowing data and applications to be shared between them.

APIs may play a critical role in both cloud and non-cloud environments by allowing developers and cloud subscribers to programmatically interact with networks providing connectivity and cloud applications. Cloud service providers may offer a variety of APIs to manage resources, automate tasks, and integrate their services with applications. Different APIs in cloud environments may include infrastructure APIs, storage APIs, networking APIs, and/or security APIs. APIs in non-cloud environments may include infrastructure and networking APIs.

However, existing APIs may not be defined based on service models and/or topologies representing cloud services allowing to build simplified and modular APIs that can be used by cloud subscribers. The existing APIs may not be defined for cloud management services, SCIs, and/or SDIs, where a cloud subscriber is attempting to access an application that is run by a cloud service provider, or by a cloud operator associated with the cloud service provider, in accordance with a cloud management service model. The existing APIs may not be defined for particular equipment, such as a customer premises equipment (CPE) to access one or more applications associated with one or more cloud service providers, in accordance with a topology. The CPE may need to access the one or more applications via one or more SCIs or SDIs, RE devices, PIP networks, and/or CE devices. As a result, due to a lack of support in the existing APIs, a customer may not be able to execute service management functions in a timely manner from a single interface, such as ordering services, monitoring services, and modifying services on-demand, thereby degrading an overall system performance. Due to lack of service models and topologies, existing APIs may not be able to hide complexities from service subscribers and presenting them end-to-end service view when requested.

In some implementations, a device, such as a management device or a client device may identify a set of APIs associated with cloud services. The set of APIs may include different subsets of APIs for different use cases. For example, the set of APIs may include a subset of APIs associated with a cloud service, a subset of APIs associated with a virtual gateway (GW) (an SCI) to a cloud operator in supporting a volume connectivity, and/or a subset of APIs associated with a GW to a combination of a carrier hotel and a cloud operator (an SDI) for a bandwidth connectivity. The device may connect to one or more entities in the cloud service based on the set of APIs, where connectivities to different entities of the one or more entities may be based on different subsets of APIs in the set of APIs. For example, the device may connect to one or more applications residing in one or more cloud service providers based on the subset of APIs associated with the cloud service. As another example, the device may connect to a cloud operator GW based on the subset of APIs associated with the SCI. As yet another example, the device may connect to an infrastructure GW and a cloud operator based on the subset of APIs associated with the SDI.

In some implementations, by the device being configured with the set of APIs associated with the cloud service, the device may be able to successfully connect to the one or more entities in the cloud environment. The device may be able to connect to the one or more entities for various services, which may include a combination of cloud subscribers, connectivity operators, and/or cloud operators. The device may be able to connect to the one or more entities for various service topologies to configure, monitor, and modify configurations on demand, which may include a combination of SCIs, REs, CEs, and/or applications associated with different cloud operators. As a result, by the set of APIs being defined to handle the various cloud services with end-to-end simplified and detailed topologies, an overall system performance and user experience with services may be improved.

In some implementations, the device, which may be connected to an API GW supporting a machine-to-machine interface, may identify a set of APIs associated with a type of cloud service. The type of cloud service may include a self-service, a co-managed service, or a fully-managed service. The device may identify a set of APIs associated with a connectivity type. The connectivity type may include a volume connectivity charged based on byte counts transmitted over a time interval, which may be associated with an SCI virtual GW with a cloud operator and a PIP network. The connectivity type may include a bandwidth connectivity charged based on connectivity bandwidth, which may be associated with an SDI connectivity cloud external network-to-network interface (ENNI) with a cloud operator and a PIP network. The device may identify a set of APIs associated with overlay components, where the overlay components may correspond to a mesh network that includes an RE, a CE, and a connectivity among CEs. Alternatively, the overlay components may correspond to a CE or an RE connectivity.

Once the service type such as the self-service, the co-managed service, or the fully-managed service is identified, the device may determine whether an underlay and/or an overlay is applicable. For the underlay, the device may identify the volume connectivity or the bandwidth connectivity. The volume connectivity may be associated with the SCI virtual GW with the cloud operator and the PIP network. The bandwidth connectivity may be associated with the PIP network and/or an infrastructure (e.g., carrier hotel infrastructure) GW and cloud operator. For the overlay, the device may identify the mesh network, the CE, or the RE connectivity. Such choice may be identified during product qualification, quoting, and ordering APIs. These APIs may be relevant operational APIs and associated payload APIs. For example, the device may only order a fully managed underlay service only, or both underlay and overlay. Within the ordering API, the device may enter desired attribute values for underlay service consisting of volume connectivity and/or bandwidth connectivity or both. The requests and responses may be supported by the combination of operational and payload APIs. Once an order is placed, the device may retrieve configuration values, an operational state, and/or an administrative state of service components, as described in service models and/or topologies.

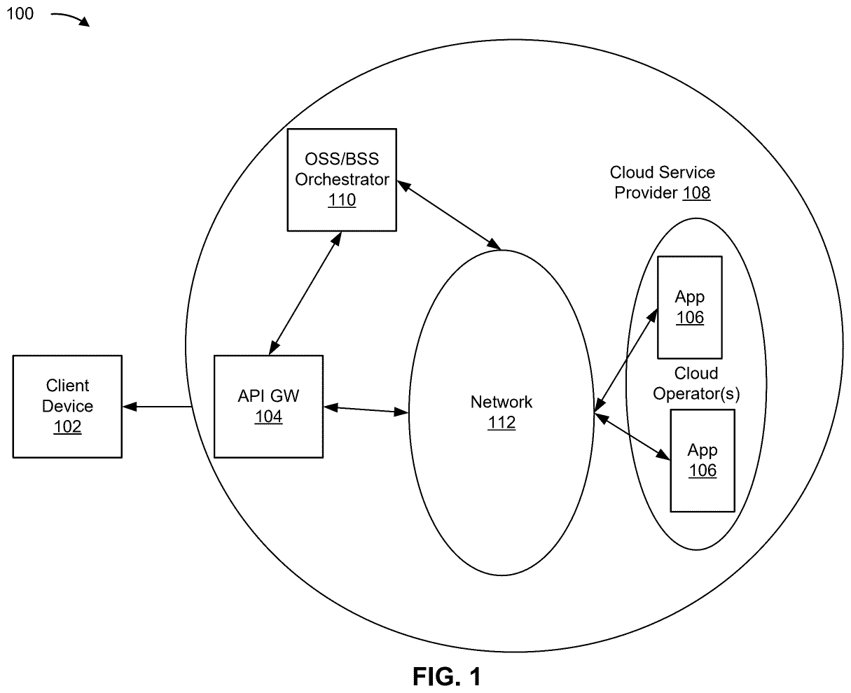

FIG. 1 is a diagram of an example 100 associated with APIs associated with cloud services. As shown in FIG. 1, example 100 includes a client device 102, an API GW 104, one or more applications 106 associated with a cloud service provider 108, an operations support system (OSS) or business support system (BSS) orchestrator 110, and a network 112. In some cases, the API GW 104 may be connected to various management systems. For example, the API GW 104 may be connected to multiple OSS, BSS systems and orchestrators of cloud services associated with the cloud service provider 108 and multiple cloud operators.

In some implementations, the client device 102 may identify a set of APIs associated with cloud services. The set of APIs may be for networks and for the one or more applications 106. The set of APIs may include a subset of APIs associated with a cloud service, a subset of APIs associated with an underlay consisting of a volume connectivity over an SCI and PIP, and/or a subset of APIs associated with a bandwidth connectivity over an SDI and PIP. The client device 102 may identify a set of APIs associated with an overlay consisting of a mesh network, CE, or RE connectivity. The client device 102 may store, in a memory associated with the device, the set of APIs associated with the cloud services in order to generate API requests and receive responses, and hold associated data. Alternatively, the client device 102 may be preconfigured with the set of APIs associated with the cloud services.

In some implementations, the set of APIs may include a subset of overlay APIs. A connectivity and a load balancing from a cloud operator GW provided by connectivity operator or cloud service provider to the one or more applications 106 associated with the one or more cloud operators may be based on the subset of overlay APIs. In some implementations, the set of APIs may include monitor-and-notify managed service APIs (e.g., self-managed APIs), co-managed service APIs, and/or fully-managed managed service APIs. The monitor-and-notify managed service APIs, the co-managed managed service APIs, and/or the fully-managed managed service APIs may include cloud service underlay payload APIs and cloud service overlay payload APIs.

In some implementations, the cloud service underlay payload APIs may be associated with a data volume connectivity and a bandwidth connectivity. The cloud service underlay payload APIs may include the subset of APIs associated with the SCI, the subset of APIs associated with the SDI, and/or a subset of APIs associated with a PIP network. The cloud service underlay payload APIs may provide connectivity and security services from a CPE to a cloud operator GW via the SCI, the RE, and the PIP network, or via the SDI, the RE, and the PIP network. The cloud service overlay payload APIs may include a subset of APIs associated with a mesh network, a subset of APIs associated with an RE, and a subset of APIs associated with a CE. The cloud service overlay payload APIs may provide management functions for connectivity, security, and load balancing services among applications associated with the cloud services. These management functions may be product catalog, product ordering, quoting, product qualifications, billing, fault management (FM), performance management (PM), security, service health, dynamic service modifications, order modifications, etc.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

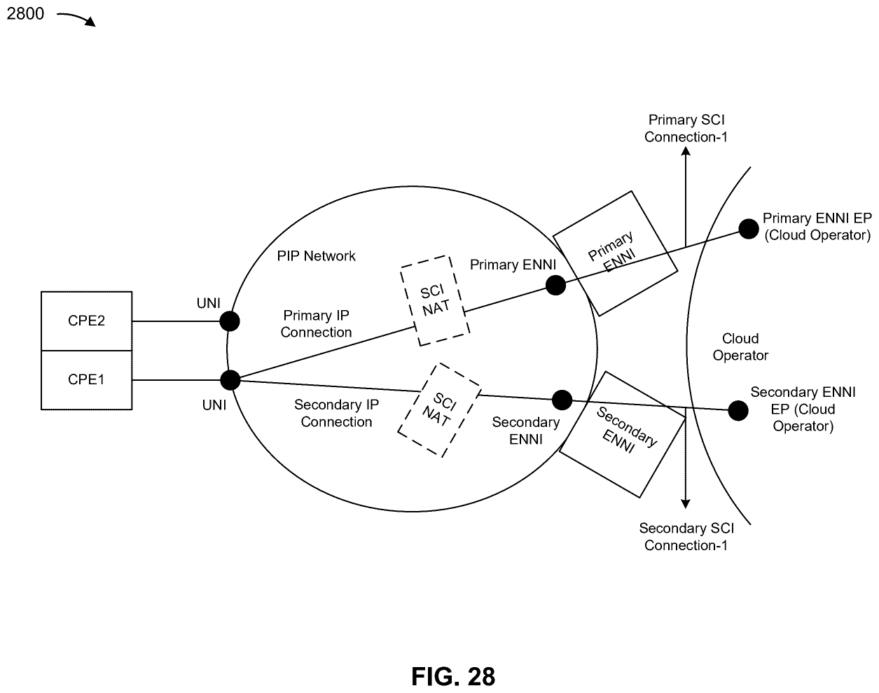

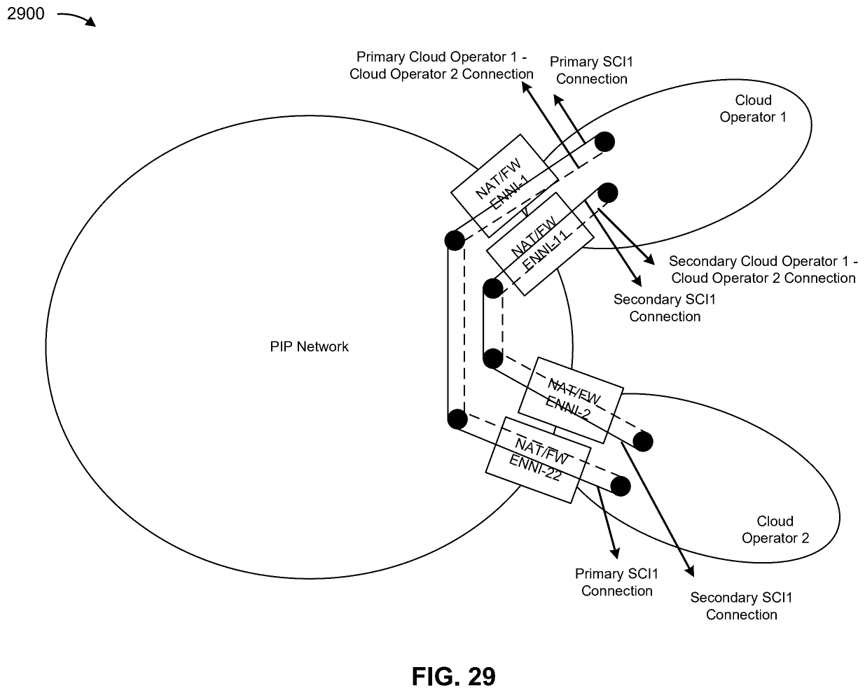

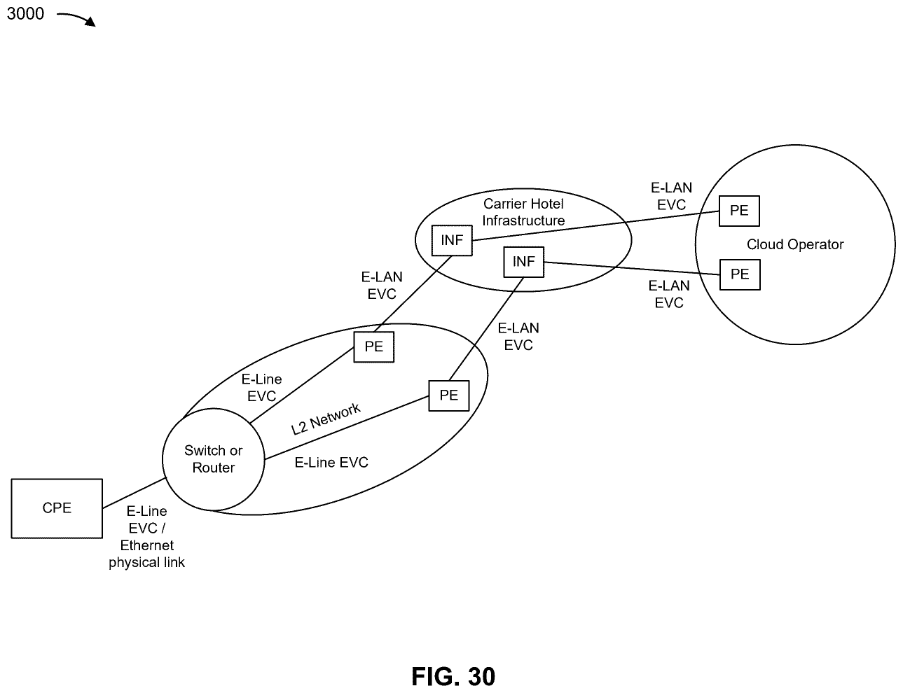

APIs for cloud service management may include APIs for connectivity from a CPE to applications residing in multiple cloud operators. The APIs for cloud service management may be associated with a service model, a topology, and an API payload definition, in addition to operational APIs. Payload APIs may be defined for an SCI. The payload APIs for the SCI may include APIs for connectivity from the CPE to a cloud operator GW (e.g., as shown in FIG. 28) or connectivity between two cloud operator GWs (e.g., as in FIG. 29). The payload APIs for the SCI may be associated with a service model, a topology, and an API payload definition. Payload APIs may be defined for an SDI. The payload APIs for the SDI may include APIs for connectivity from the CPE to an infrastructure GW and a cloud operator (e.g., as shown in FIGS. 30-32). The infrastructure GW may be associated with a carrier hotel, which may be a carrier-neutral data center providing connectivity among telecommunications and cloud operators. The APIs for the SDI may be associated with a service model, a topology, and an API payload definition. APIs may be defined for an overlay. The overlay may be components of the cloud service. The APIs for the overlay may include APIs for RE and CE, connectivity, security, and load balancing from a cloud Operator GW to applications, in addition to operational APIs. The load balancing payload API may include web access filtering (WAF) and additional security capability APIs. The APIs for the overlay may be associated with a service model, a topology, and a payload API definition.

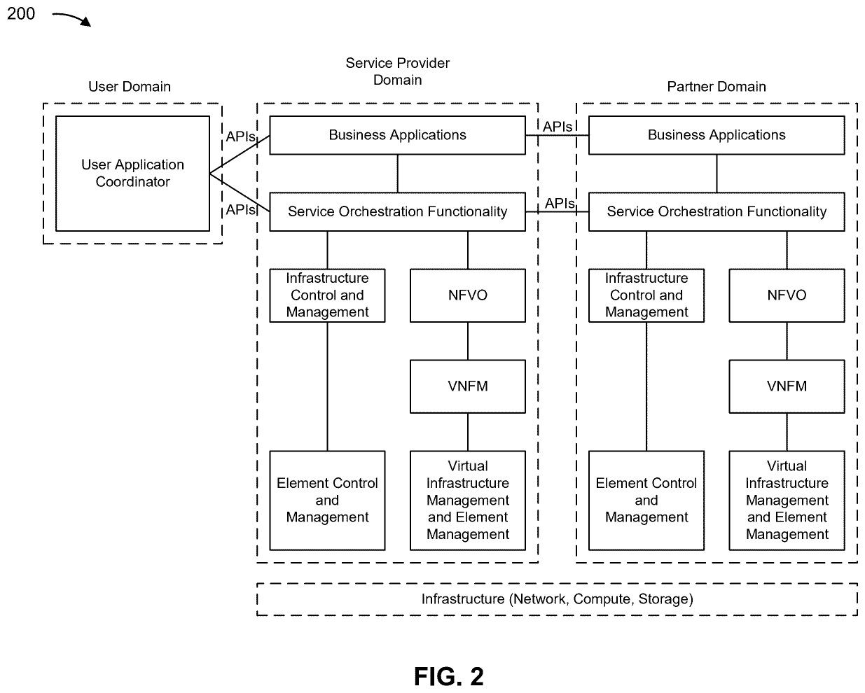

FIG. 2 is a diagram of an example 200 associated with MEF standard interfaces for APIs. These interfaces may be customer-service provider and service provider-partner interfaces supporting business functions such as cataloging, quoting, ordering and billing products via OSS/BSS; and service functions such as configurations, modifications, testing, fault monitoring, health monitoring, and performance monitoring via orchestrators. In a cloud services model, a service provider (e.g., a connectivity operator) such as a telecommunications service provider or partner (e.g., cloud operator) may be a cloud service provider which is a single point of contact for customer and responsible from the end-to-end service.

As shown in FIG. 2, APIs for MEF lifecycle service orchestration (LSO) standard interfaces may be defined. The APIs may be built for standard interfaces to achieve interoperability. A user domain (customer domain) may be associated with a user application coordinator. A service provider (SP) domain may be associated with business applications, service orchestration functionality, infrastructure control and management, a network function virtualization orchestrator (NFVO), a virtual network function manager (VNFM), element control and management, and/or virtual infrastructure management and element management. A partner domain may be associated with business applications, service orchestration functionality, infrastructure control and management, an NFVO, a VNFM, element control and management, and/or virtual infrastructure management and element management. Different elements of the user domain, the SP domain, and/or the partner domain may communicate with each other via APIs over the MEF LSO standard interfaces. The user domain, the SP domain, and the partner domain may be associated with an infrastructure (e.g., network, compute, and/or storage).

As indicated above, FIG. 2 is provided as an example. Other examples may differ from what is described with regard to FIG. 2.

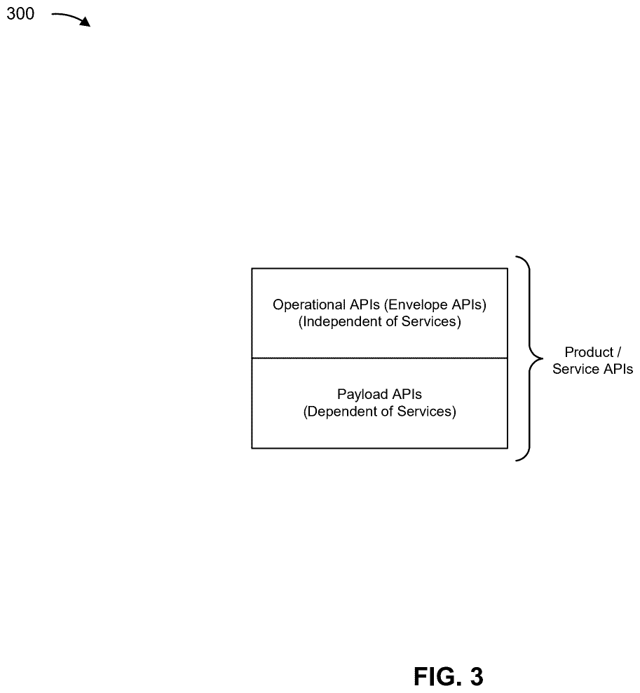

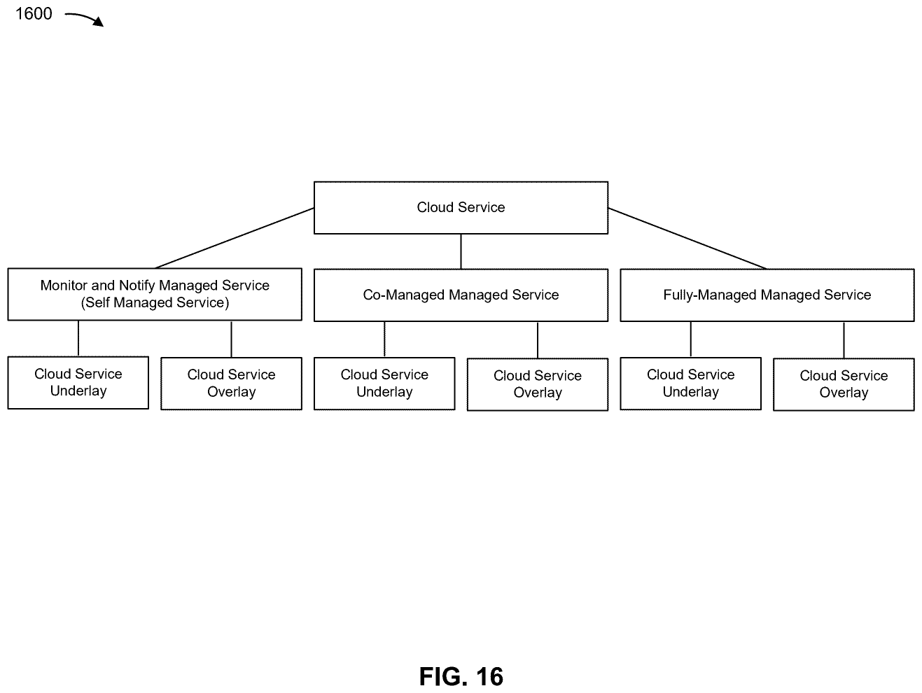

FIG. 3 is a diagram of an example 300 associated with an MEF API structure for building APIs for LSO standard interfaces. This approach may be used in building cloud service APIs (e.g., as shown in FIGS. 16-26).

As shown in FIG. 3, the MEF API structure may be modular to support reuse among services. The MEF API structure may include operational APIs (envelope APIs) and payload APIs. The operational APIs may be independent from services that can be used for all services. The payload APIs may be specific to services that can be used among similar services. In other words, the operational APIs may be independent of services, and the payload APIs may be dependent on services. The operational APIs and the payload APIs may be associated with product/service APIs.

As indicated above, FIG. 3 is provided as an example. Other examples may differ from what is described with regard to FIG. 3.

FIG. 4 is a diagram of an example 400 associated with a cloud services architecture.

As shown in FIG. 4, in the cloud services architecture, a cloud subscriber may communicate with a cloud service provider via a cloud user network interface (UNI). The cloud service provider may be associated with a subscriber cloud virtual connection (VC). The subscriber cloud VC may be defined by a first subscriber cloud VC endpoint (EP) and a second subscriber cloud VC EP (when a point-to-point VC). The second subscriber cloud VC EP may be associated with a cloud application interface. The cloud application interface may be associated with a cloud application, where the cloud operator may run the cloud application while the cloud service provider monitors the health and performance of the cloud application.

As indicated above, FIG. 4 is provided as an example. Other examples may differ from what is described with regard to FIG. 4.

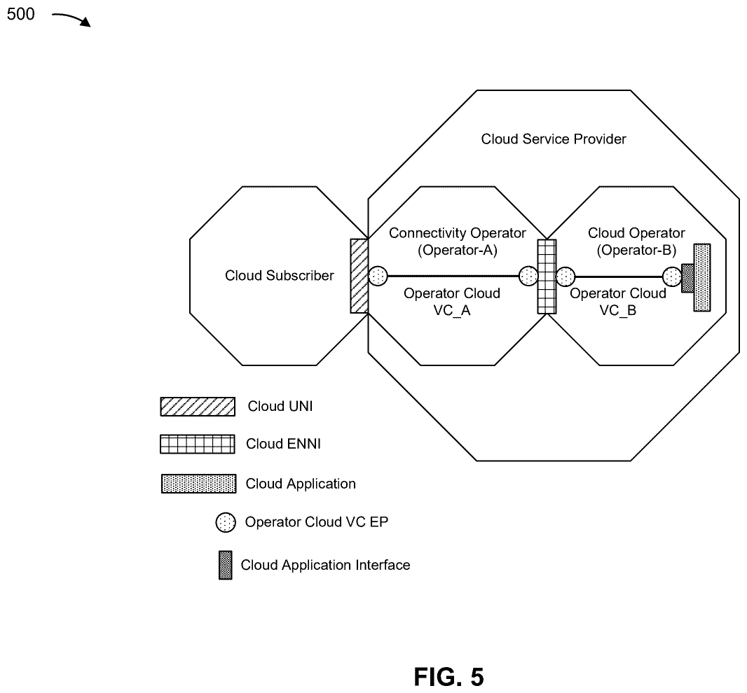

FIG. 5 is a diagram of an example 500 associated with a cloud services architecture.

As shown in FIG. 5, in the cloud services architecture, a cloud user may communicate with a cloud service provider via a cloud UNI. The cloud service provider may be associated with a connectivity operator (Operator-A) and a cloud operator (Operator-B). The connectivity operator may be associated with an operator cloud VC (VCA), which may be defined by a first operator cloud VC EP and a second operator cloud VC EP. The cloud operator may be associated with an operator cloud VC (VCB), which may be defined by a first operator cloud VC EP and a second operator cloud VC EP. The connectivity operator may communicate with the cloud operator via a cloud ENNI. Similarly, a cloud operator may communicate with another cloud operator via a cloud ENNI. The operator cloud VC (VCB) may be associated with a cloud application interface. The cloud application interface may be associated with a cloud application, where the cloud application may be run by the cloud operator associated with the cloud service provider.

As indicated above, FIG. 5 is provided as an example. Other examples may differ from what is described with regard to FIG. 5.

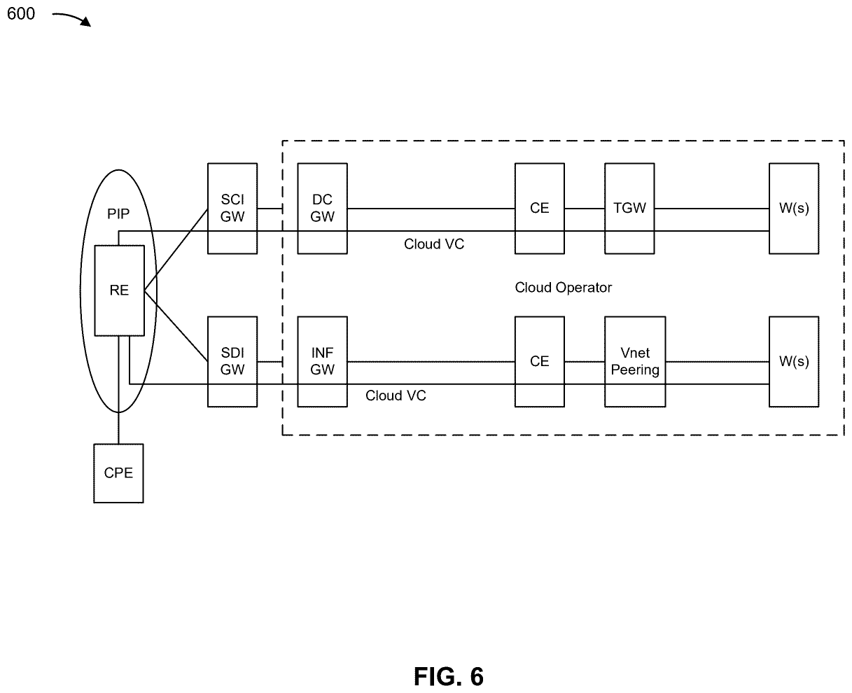

FIG. 6 is a diagram of an example 600 associated with a cloud service architecture.

As shown in FIG. 6, in the cloud service architecture, a PIP network may include an RE. The RE may be associated with a GLB which is another load balancer for distributing traffic among multiple cloud operators. The PIP network may communicate with a CPE at customer locations. The PIP network may communicate with an RE, SCI GW, a direct connect (DC) GW provided by a cloud operator, a first CE (e.g., one or more servers) associated with an LB, a transit GW (TGW) provided by a cloud operator, and a first group of workloads (W) (e.g., applications). The PIP network may also communicate with an RE, SDI GW, an infrastructure (INF) GW provided by another cloud operator, a second CE associated with an LB, a virtual network (Vnet) peering entity provided by another cloud operator, and a second group of workloads. In some implementations, “underlay” may refer to the CPE, the PIP network, the SCI GW, and the SDI GW. “Overlay” may refer to entities beyond entities that are associated with the underlay. For example, “overlay” may refer to cloud entities, such as the RE, DC GW, the infrastructure GW, and so on.

As indicated above, FIG. 6 is provided as an example. Other examples may differ from what is described with regard to FIG. 6.

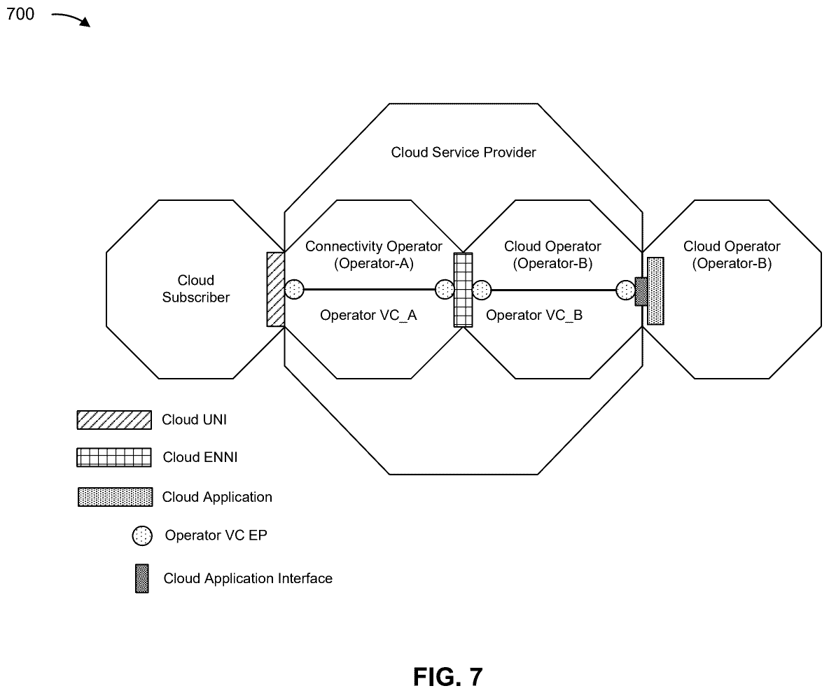

FIG. 7 is a diagram of an example 700 associated with a cloud service model.

As shown in FIG. 7, in the cloud service model, a cloud subscriber may communicate with a cloud service provider via a cloud UNI. The cloud service provider may be associated with a connectivity operator (Operator-A) and a cloud operator (Operator-B). The connectivity operator may be associated with an operator cloud VC (VCA), which may be defined by a first operator cloud VC EP and a second operator cloud VC EP. The cloud operator may be associated with an operator cloud VC (VCB), which may be defined by a first operator cloud VC EP and a second operator cloud VC EP. The connectivity operator may communicate with the cloud operator via a cloud ENNI. The cloud operator, outside of the cloud service provider, may be associated with a cloud application. The cloud operator within the cloud service provider and the cloud operator outside of the cloud service provider may communicate via a cloud application interface.

As indicated above, FIG. 7 is provided as an example. Other examples may differ from what is described with regard to FIG. 7.

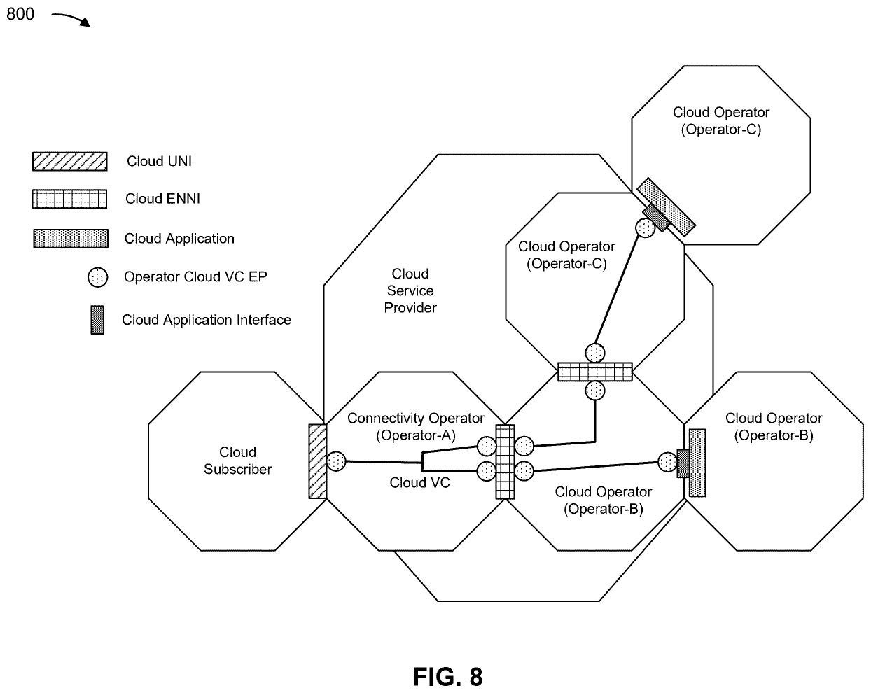

FIG. 8 is a diagram of an example 800 associated with a cloud service model.

As shown in FIG. 8, in the cloud service model, a cloud subscriber may communicate with a cloud service provider via a cloud UNI. The cloud service provider may be associated with a connectivity operator (Operator-A), a first cloud operator (Operator-B), and a second cloud operator (Operator-C). The connectivity operator may communicate with the first cloud operator via a cloud ENNI. The first cloud operator may communicate with the second cloud operator via a cloud ENNI. The connectivity operator, the first cloud operator, and the second cloud operator may include various operator cloud VC EPs to enable communications between the cloud subscriber, the connectivity operator, the first cloud operator, and/or the second cloud operator. The second cloud operator, outside of the cloud service provider, may be associated with a cloud application. The third cloud operator, outside of the cloud service provider, may be associated with a cloud application. Such cloud applications may be accessed via respective cloud application interfaces, where cloud application interfaces are the demarcation points between the cloud service provider and cloud operators for supporting cloud applications. A cloud VC, which may be in between a cloud subscriber and applications, may be a multipoint VC allowing the subscriber to use applications in multiple operators simultaneously.

As indicated above, FIG. 8 is provided as an example. Other examples may differ from what is described with regard to FIG. 8.

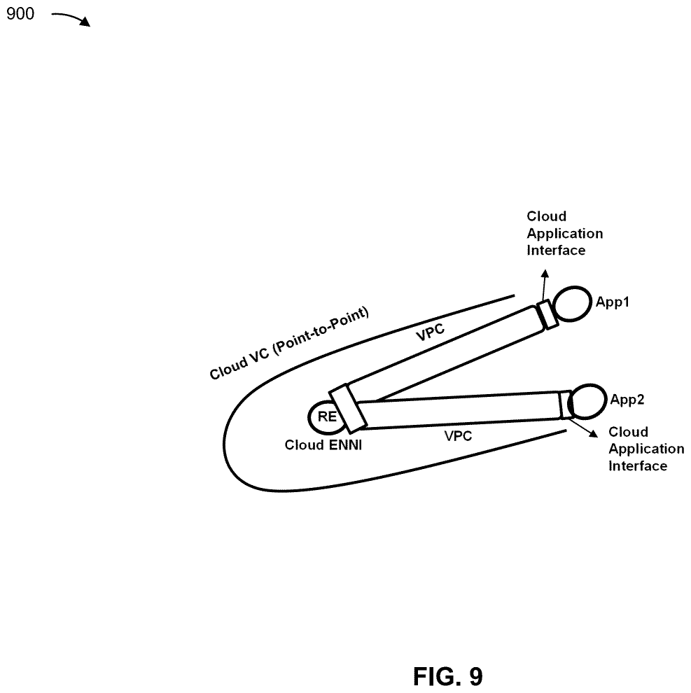

FIG. 9 is a diagram of an example 900 associated with a mesh network.

As shown in FIG. 9, in the mesh network provided by a single cloud operator, an RE may be associated with a cloud ENNI, which is the interface between a connectivity operator, which is also acting as a cloud service provider, and a cloud operator. The connectivity operator is not shown in FIG. 9. The RE may communicate with a first application (App) via a first virtual private cloud (VPC). The first application may be associated with a first cloud application interface. The RE may communicate with a second application via a second VPC. The second application may be associated with a second cloud application interface. The first application and the second application may be connected via a cloud VC (e.g., a point-to-point connection). In this example, the cloud ENNI may be between two segments of cloud VCs. The cloud ENNI may be provided by the RE, which may support L3 IP connectivity, WAF, security, and/or load balancing capabilities.

As indicated above, FIG. 9 is provided as an example. Other examples may differ from what is described with regard to FIG. 9.

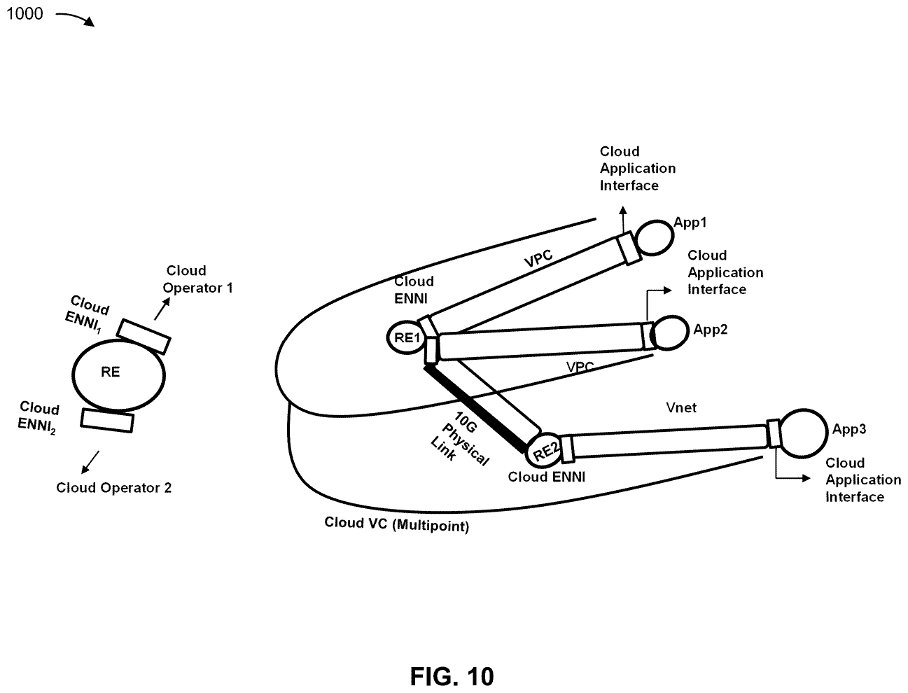

FIG. 10 is a diagram of an example 1000 associated with a mesh network.

As shown in FIG. 10, in the mesh network, a first RE may be associated with a first cloud ENNI and a second RE may be associated with a second cloud ENNI. The first RE and the second RE may be connected via a physical (PHY) link or network. The first cloud ENNI may be associated with a first cloud operator, and the second cloud ENNI may be associated with a second cloud operator. The first RE may communicate with a first application and a second application via respective VPCs. The second RE may communicate with a third application via a Vnet. Each application may be associated with a cloud application interface. The first application, the second application, and the third application may be connected via a cloud VC (e.g., a multipoint connection). In this example, a cloud ENNI among cloud operators may be provided by an RE supporting L2, and/or L3 connectivity, WAF, security, and/or load balancing capabilities. The cloud ENNI may have different attributes for each cloud operator. The RE may be provided by a connectivity operator.

As indicated above, FIG. 10 is provided as an example. Other examples may differ from what is described with regard to FIG. 10.

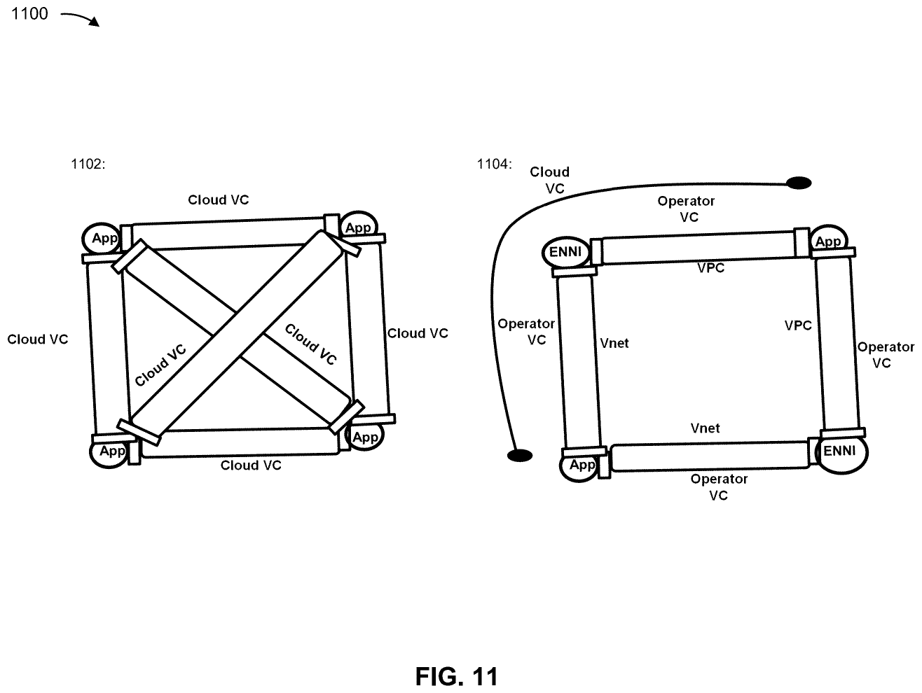

FIG. 11 is a diagram of an example 1100 associated with a mesh network.

In some implementations, the mesh network may be without an RE and an SCI or SDI. As shown by reference number 1102, fully connected applications may be in a same cloud operator. Each application may communicate with another application via a cloud VC. As shown by reference number 1104, connected applications may be in two different cloud operators. The two different cloud operators may be connected via ENNI and cloud VC segments in each cloud operator, which may be referred to as a cloud operator VC, as depicted in FIG. 7. Different applications in different cloud operator domains may communicate over ENNI and cloud operator VCs.

As indicated above, FIG. 11 is provided as an example. Other examples may differ from what is described with regard to FIG. 11.

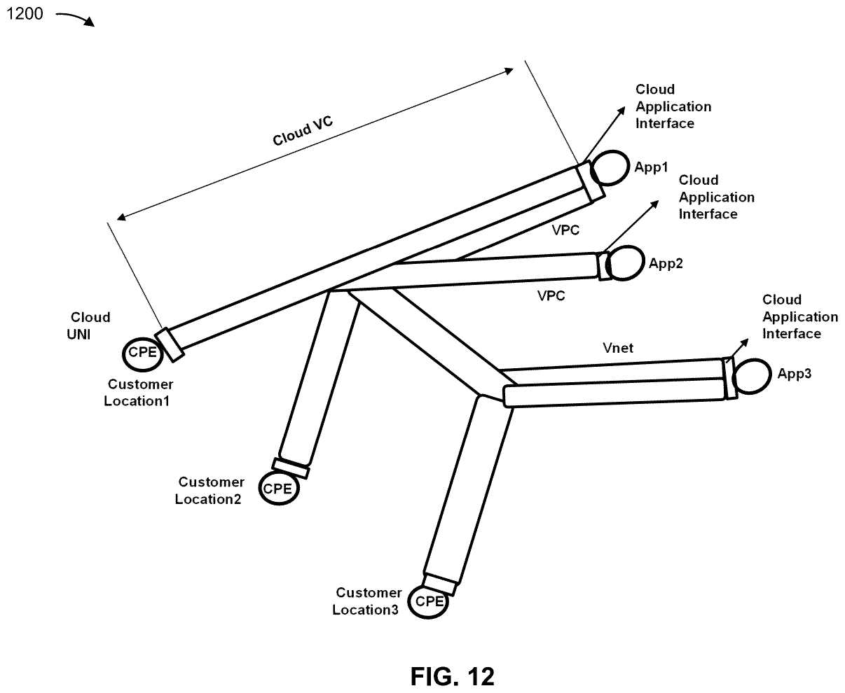

FIG. 12 is a diagram of an example 1200 associated with a cloud service topology.

As shown in FIG. 12, in the cloud service topology, a first CPE may be associated with a first user (or customer) location, a second CPE may be associated with a second user (or customer) location, and a third CPE may be associated with a third user (or customer) location. The first CPE may be associated with a cloud UNI. The first CPE may be associated with a first application, the second CPE may be associated with a second application, and the third CPE may be associated with a third application. The first application and the second application may be associated with a first cloud network, and the third application may be associated with a second cloud network. Each application may be associated with a cloud application interface. Different CPEs may be connected with different applications using cloud VCs and/or IP connections. A cloud VC may be an end-to-end connection. In some implementations, the cloud service topology may define a structure of various underlay and overlay service components. APIs may be used to generate information, such as configuration information, fault management information, health and security information, and/or performance information about all service components.

As indicated above, FIG. 12 is provided as an example. Other examples may differ from what is described with regard to FIG. 12.

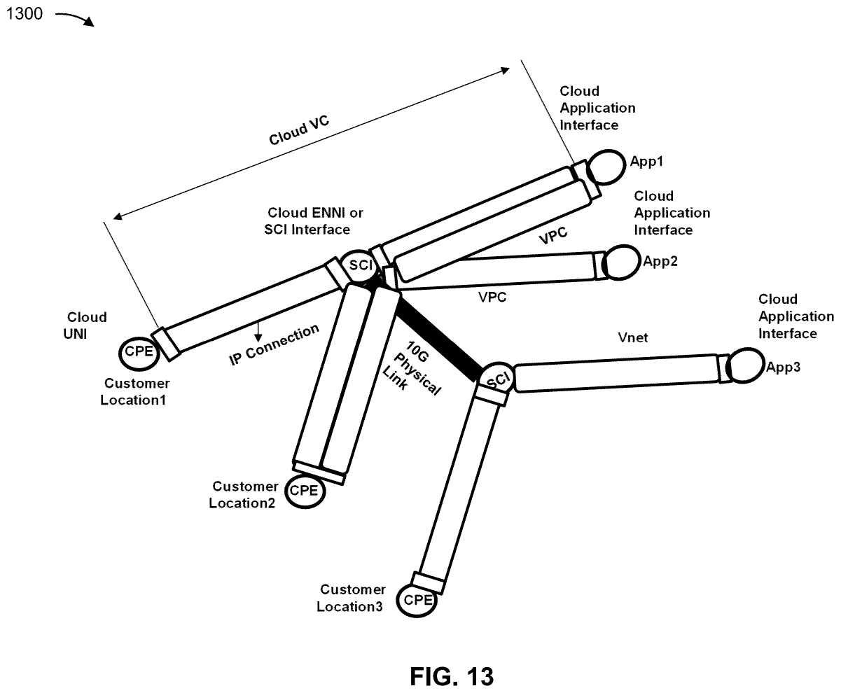

FIG. 13 is a diagram of an example 1300 associated with a cloud service topology.

As shown in FIG. 13, in the cloud service topology, a first CPE may be associated with a first customer location, a second CPE may be associated with a second customer location, and a third CPE may be associated with a third customer location. A first SCI may be associated with the first CPE and the second CPE. The first SCI may be associated with a cloud ENNI or an SCI interface. The first SCI may be connected to the first CPE and the second CPE via respective IP connections. The first SCI may be connected to a first application and a second application via respective VPCs. The first CPE may be connected to the first application via a cloud VC. A second SCI may be associated with the third CPE. The second SCI may be connected to a third application via a Vnet. The first SCI and the second SCI may be connected via a PHY link. Each application may be associated with a cloud application interface.

As indicated above, FIG. 13 is provided as an example. Other examples may differ from what is described with regard to FIG. 13.

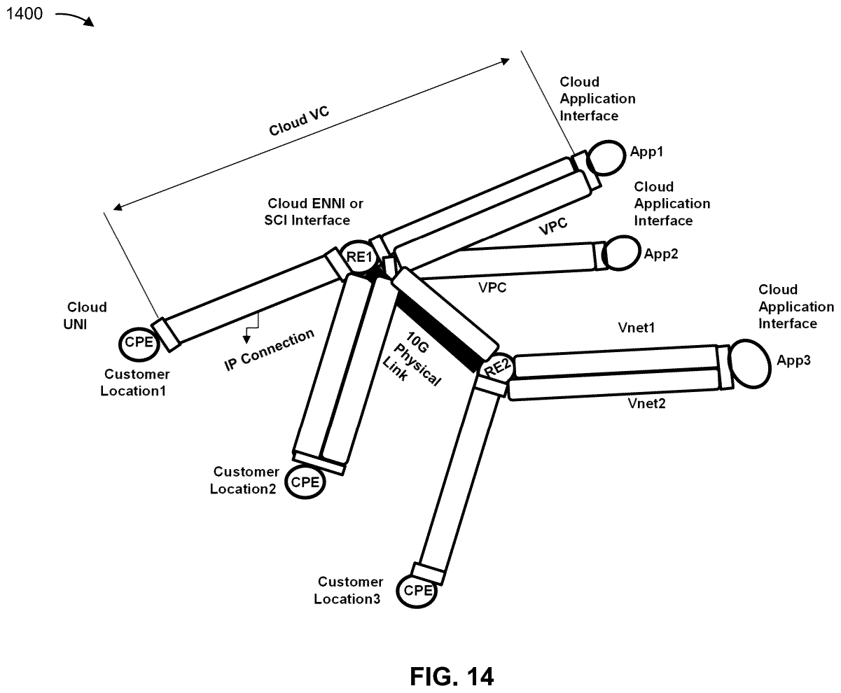

FIG. 14 is a diagram of an example 1400 associated with a cloud service topology.

As shown in FIG. 14, in the cloud service topology, a first CPE may be associated with a first customer location, a second CPE may be associated with a second customer location, and a third CPE may be associated with a third customer location. A first RE may be associated with the first CPE and the second CPE. The first RE may be associated with a cloud service network to network interface (NNI). The first RE may be associated with a cloud ENNI or an SCI interface. The first RE may be connected to the first CPE and the second CPE via respective IP connections. The first RE may be connected to a first application and a second application via respective VPCs. The first CPE may be connected to the first application via a cloud VC. A second RE may be associated with the third CPE. The second RE may be connected to a third application via a first Vnet and a second Vnet. The first RE and the second RE may be connected via a PHY link. Each application may be associated with a cloud application interface.

As indicated above, FIG. 14 is provided as an example. Other examples may differ from what is described with regard to FIG. 14.

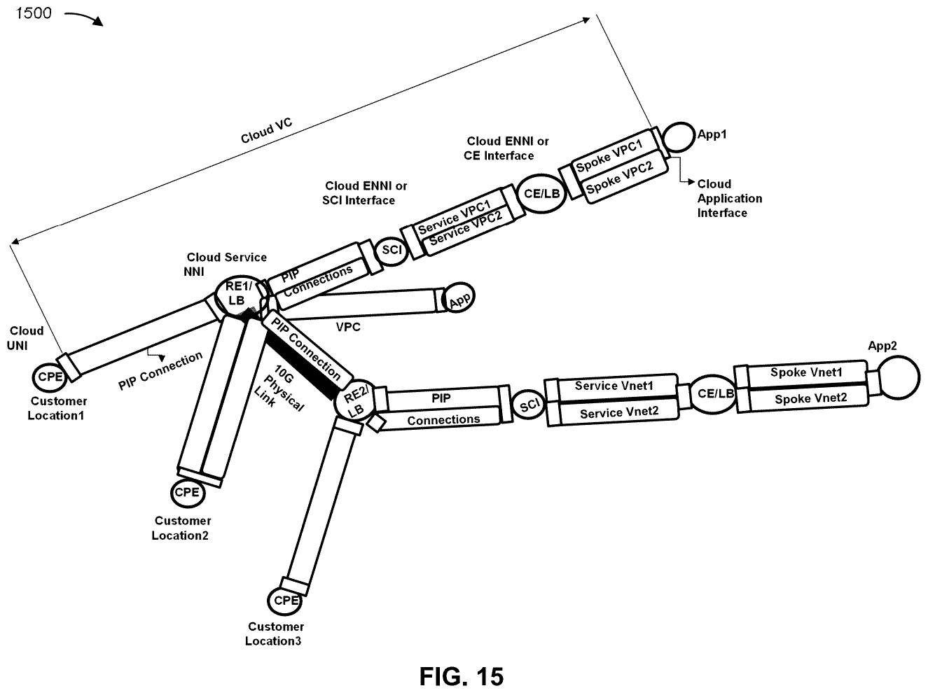

FIG. 15 is a diagram of an example 1500 associated with a cloud service topology.

As shown in FIG. 15, in the cloud service topology, a first CPE may be associated with a first customer location, a second CPE may be associated with a second customer location, and a third CPE may be associated with a third customer location. A first RE may be associated with the first CPE and the second CPE. The first RE may include a GLB. The first RE may be associated with a cloud service NNI, which may be an internal interface of a connectivity operator. The first RE may be connected to the first CPE and the second CPE via respective PIP connections. The first RE may be connected to a first SCI via one or more PIP connections. The first SCI may be associated with a cloud ENNI or an SCI interface. The first SCI may be connected to a first CE cluster of servers via one or more VPCs. In this example, an SCI may be connected to CE servers via a first service VPC and a second VPC. The first CE may include an LB. The first CE may be associated with an application interface or a CE interface. The first CE may be connected to a first application via a first spoke VPC and a second spoke VPC forming the application interface which is a demarcation point between the first application and the cloud service. The first CPE may be connected to the first application via an end-to-end connection cloud VC.

As further shown in FIG. 15, the first RE may be connected to a second application via a VPC. A second RE may be connected to the third CPE via a PIP connection. The second RE may include a GLB. The first RE and the second RE may be connected via a PHY link and/or a network. The second RE may be connected to a second SCI via one or more PIP connections. The second SCI may be connected to a second CE via a first service VPC and a second VPC. The second CE may include an LB. The second CE may be connected to a third application via a first spoke VPC and a second spoke VPC.

As indicated above, FIG. 15 is provided as an example. Other examples may differ from what is described with regard to FIG. 15.

FIG. 16 is a diagram of an example 1600 associated with an API hierarchy for a cloud service.

As shown in FIG. 16, in the API hierarchy, a cloud service may be associated with a monitor-and-notify managed service (e.g., a self-managed service which is configured by a customer, and monitored and customer notified for failures by a cloud service provider), a co-managed managed service which may be managed by a customer and a cloud service provider, and a fully-managed managed service which may be managed by a cloud service provider only). The monitor-and-notify managed service may be associated with a cloud service underlay and a cloud service overlay. The co-managed managed service may be associated with a cloud service underlay and a cloud service overlay. The fully-managed managed service may be associated with a cloud service underlay and a cloud service overlay.

As indicated above, FIG. 16 is provided as an example. Other examples may differ from what is described with regard to FIG. 16.

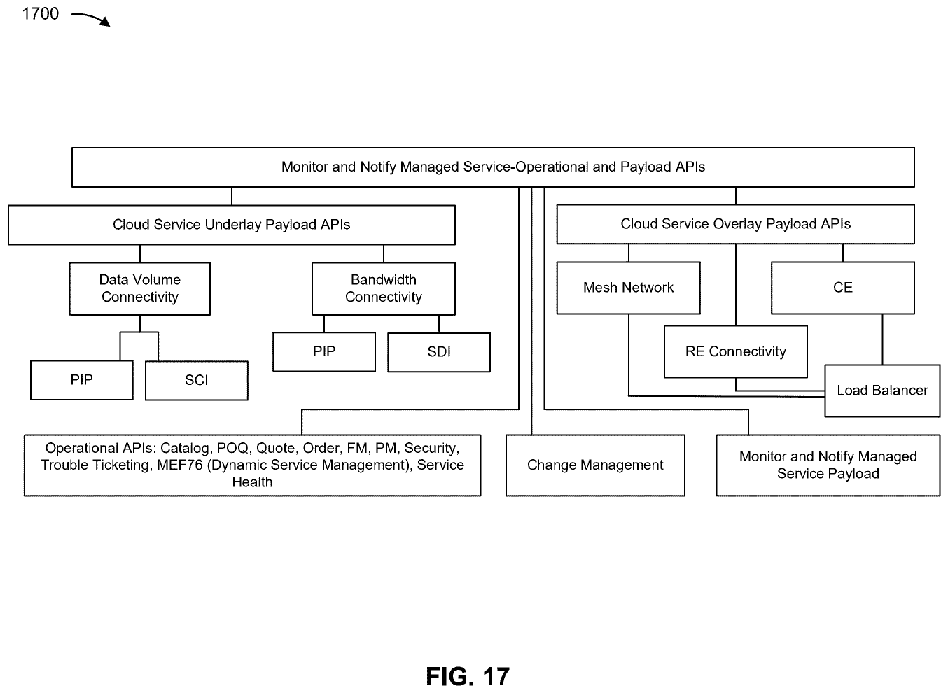

FIG. 17 is a diagram of an example 1700 associated with a monitor-and-notify managed service.

As shown in FIG. 17, the monitor-and-notify managed service (e.g., a self-managed service) may be associated with cloud service underlay payload APIs, operational APIs, cloud service overlay payload APIs, a change management API, and/or a monitor-and-notify managed service payload. Each API may be associated with various attributes. The cloud service underlay payload APIs may be associated with a data volume connectivity and/or a bandwidth connectivity. The data volume connectivity may be associated with a PIP network and/or an SCI. The bandwidth connectivity may be associated with the PIP network and/or an SDI. The operational APIs may be associated with catalogs, product order quantification (POQ), quotes, orders, fault management, performance management, security, trouble ticketing, dynamic service management, testing, and/or service health. The operational APIs may be end-to-end APIs that are tied into sub-product APIs. The change management API may be part of an order API, where the order API may be included in the operational APIs, or the change management API supporting change requests during service ordering may be a separate API. The cloud service overlay payload APIs may be associated with a mesh network (e.g., layer 3 (L3), or L3 plus L7), an RE connectivity, and/or a CE (e.g., L3, L3 plus L7, or highly available (HA)). The mesh network, the RE connectivity, and/or the CE may be associated with an LB. The monitor-and-notify managed service payload may include all of the cloud service underlay payload APIs and the cloud service overlay payload APIs. The HA API for the CE may provide a management of CE redundancy (active-active or active-passive).

As indicated above, FIG. 17 is provided as an example. Other examples may differ from what is described with regard to FIG. 17.

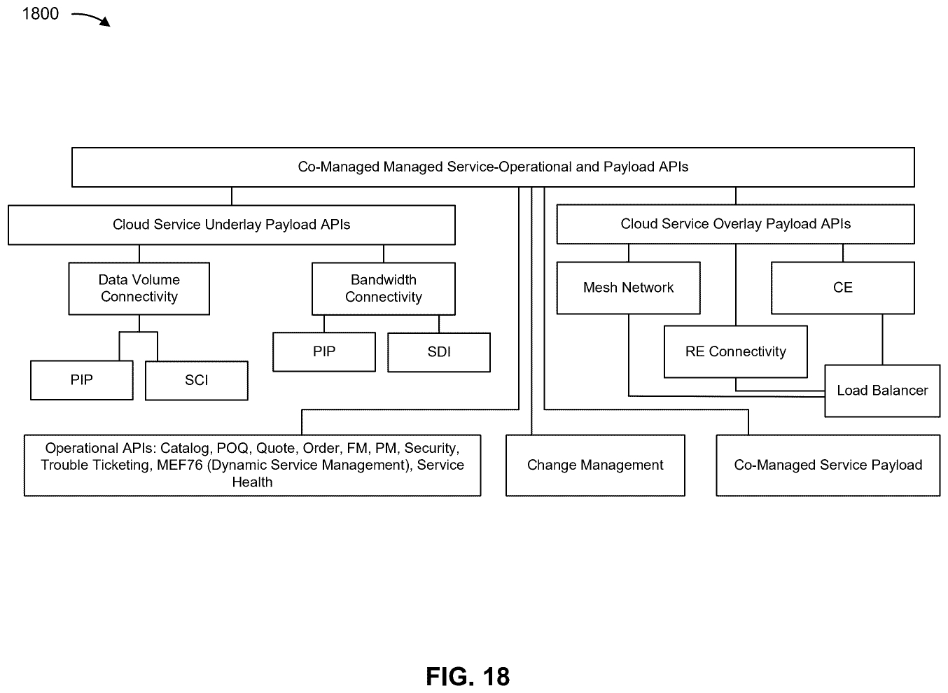

FIG. 18 is a diagram of an example 1800 associated with a co-managed managed service.

As shown in FIG. 18, the co-managed managed service may be associated with cloud service underlay payload APIs, operational APIs, cloud service overlay payload APIs, a change management API, and/or a co-managed service payload. In some implementations, “underlay” may refer to a CPE, a PIP network, an SCI GW, and an SDI GW, and “overlay” may refer to entities beyond entities that are associated with the underlay. Each API may be associated with various attributes. The cloud service underlay payload APIs may be associated with a data volume connectivity and/or a bandwidth connectivity. The data volume connectivity may be associated with a PIP network and/or an SCI. The bandwidth connectivity may be associated with the PIP network and/or an SDI. The operational APIs may be associated with catalogs, POQ, quotes, orders, fault management, performance management, security, trouble ticketing, dynamic service management, testing, and/or service health. The operational APIs may be end-to-end APIs that are tied into sub-product APIs. The change management API may be part of an order API, where the order API may be included in the operational APIs, or the change management API may be a separate API. The cloud service overlay payload APIs may be associated with a mesh network (e.g., L3, or L3 plus L7), an RE connectivity, and/or a CE (e.g., L3, L3 plus L7, or HA). The mesh network, the RE connectivity, and/or the CE may be associated with an LB. The co-managed service payload may include all of the cloud service underlay payload APIs and the cloud service overlay payload APIs.

As indicated above, FIG. 18 is provided as an example. Other examples may differ from what is described with regard to FIG. 18.

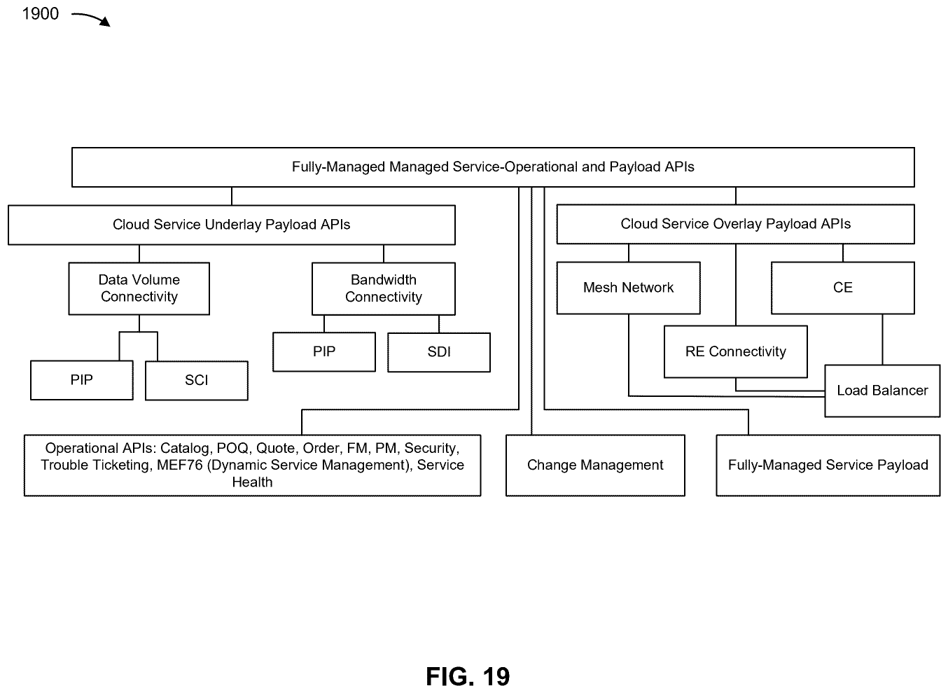

FIG. 19 is a diagram of an example 1900 associated with a fully-managed managed service.

As shown in FIG. 19, the fully-managed managed service may be associated with cloud service underlay payload APIs, operational APIs, cloud service overlay payload APIs, a change management API, and/or a fully-managed service payload. Each API may be associated with various attributes. The cloud service underlay payload APIs may be associated with a data volume connectivity and/or a bandwidth connectivity. The data volume connectivity may be associated with a PIP network and/or an SCI. The bandwidth connectivity may be associated with the PIP network and/or an SDI. The operational APIs may be associated with catalogs, POQ, quotes, orders, fault management, performance management, security, trouble ticketing, dynamic service management, testing, and/or service health. The operational APIs may be end-to-end APIs that are tied into sub-product APIs. The change management API may be part of an order API, where the order API may be included in the operational APIs, or the change management API may be a separate API. The cloud service overlay payload APIs may be associated with a mesh network (e.g., L3, or L3 plus L7), an RE connectivity, and/or a CE (e.g., L3, L3 plus L7, or HA). The mesh network, the RE connectivity, and/or the CE may be associated with an LB. The fully-managed service payload may include all of the cloud service underlay payload APIs and the cloud service overlay payload APIs.

As indicated above, FIG. 19 is provided as an example. Other examples may differ from what is described with regard to FIG. 19.

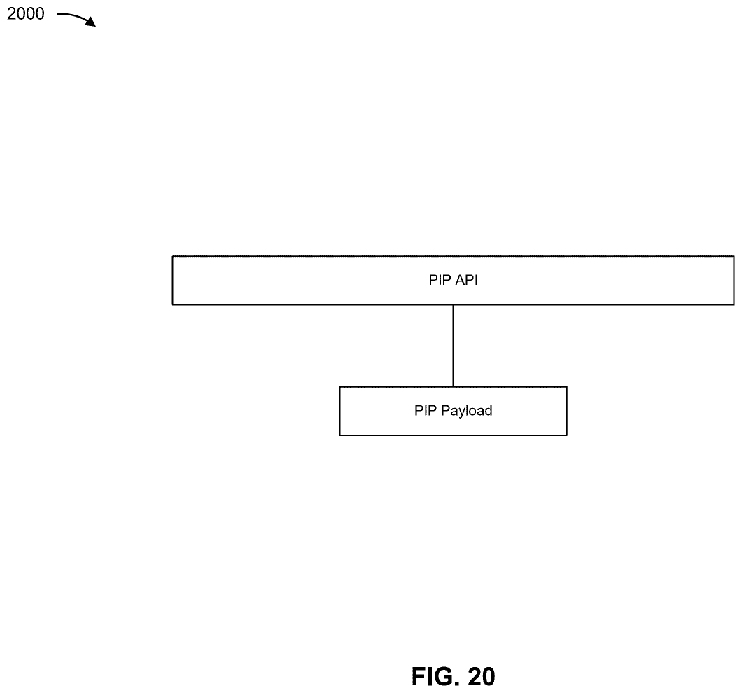

FIG. 20 is a diagram of an example 2000 associated with a PIP API.

As shown in FIG. 20, the PIP API may be associated with a PIP payload. Operational APIs for a PIP network, which may be a cloud service component, may not be needed. Cloud service managed service operational (envelope APIs) may cover all cloud service components.

As indicated above, FIG. 20 is provided as an example. Other examples may differ from what is described with regard to FIG. 20.

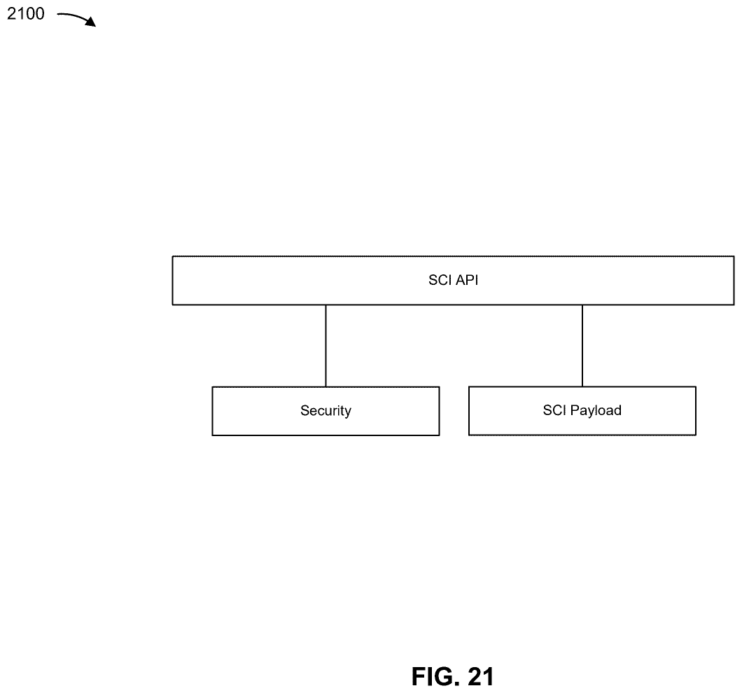

FIG. 21 is a diagram of an example 2100 associated with an SCI API.

As shown in FIG. 21, the SCI API may be an API for a virtual GW (cloud ENNI) interface between a connectivity operator and a cloud operator. An SCI payload AP may be associated with a security payload and an SCI payload. Operational APIs for an SCI, which may be a cloud service component, may not be needed. Cloud service managed service operational (envelope APIs) may cover all cloud service components. The security payload API may be part of an SCI payload, unless an SCI network address translation (NAT) or firewall (FW) is ordered separately.

As indicated above, FIG. 21 is provided as an example. Other examples may differ from what is described with regard to FIG. 21.

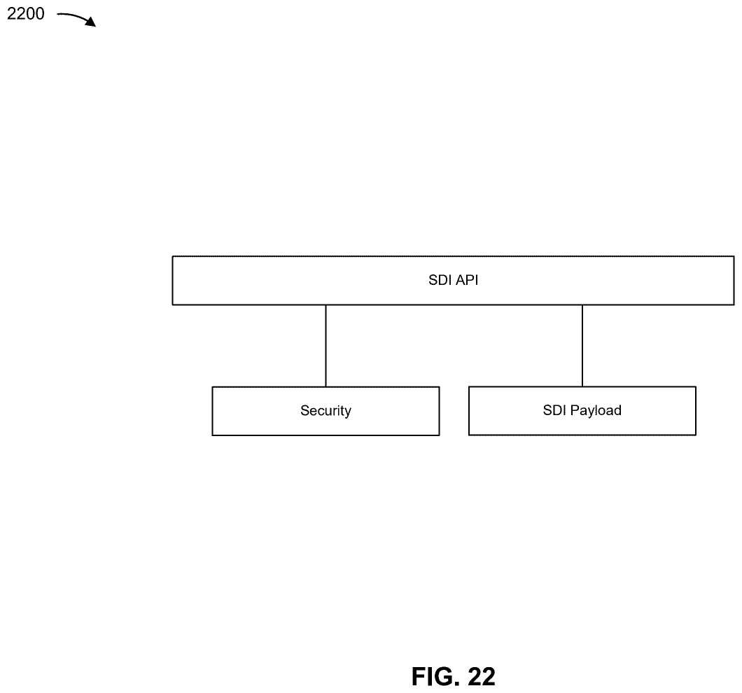

FIG. 22 is a diagram of an example 2200 associated with an SDI API.

As shown in FIG. 22, the SDI API may be a cloud ENNI API for a combination of interfaces between a connectivity operator and a carrier hotel, and the connectivity operator and a cloud operator. An SDI payload API may be associated with a security payload and an SDI payload. Operational APIs for an SDI, which may be a cloud service component, may not be needed. Cloud service managed service operational APIs (envelope APIs) may cover all cloud service components. The security payload may be part of an SDI payload, unless an SDI NAT or FW is ordered separately.

As indicated above, FIG. 22 is provided as an example. Other examples may differ from what is described with regard to FIG. 22.

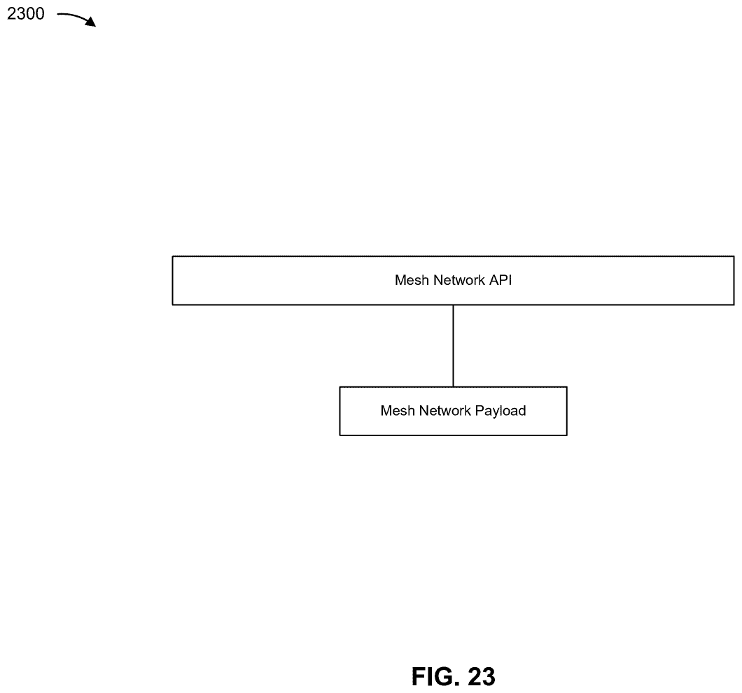

FIG. 23 is a diagram of an example 2300 associated with a mesh network API.

As shown in FIG. 23, the mesh network API may be associated with a mesh network payload. Operational APIs for a mesh network, which may be a cloud service component, may not be needed. Cloud service managed service operational (envelope) APIs may cover all cloud service components.

As indicated above, FIG. 23 is provided as an example. Other examples may differ from what is described with regard to FIG. 23.

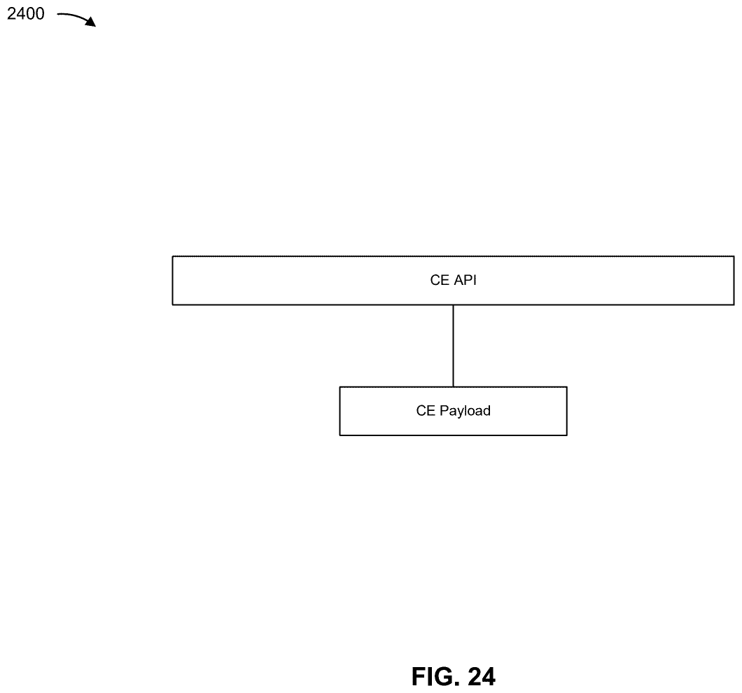

FIG. 24 is a diagram of an example 2400 associated with a CE API.

As shown in FIG. 24, the CE API may be associated with a CE payload. Operational APIs for a CE, which may be a cloud service component, may not be needed. Cloud service operational (envelope) APIs may cover all cloud service components.

As indicated above, FIG. 24 is provided as an example. Other examples may differ from what is described with regard to FIG. 24.

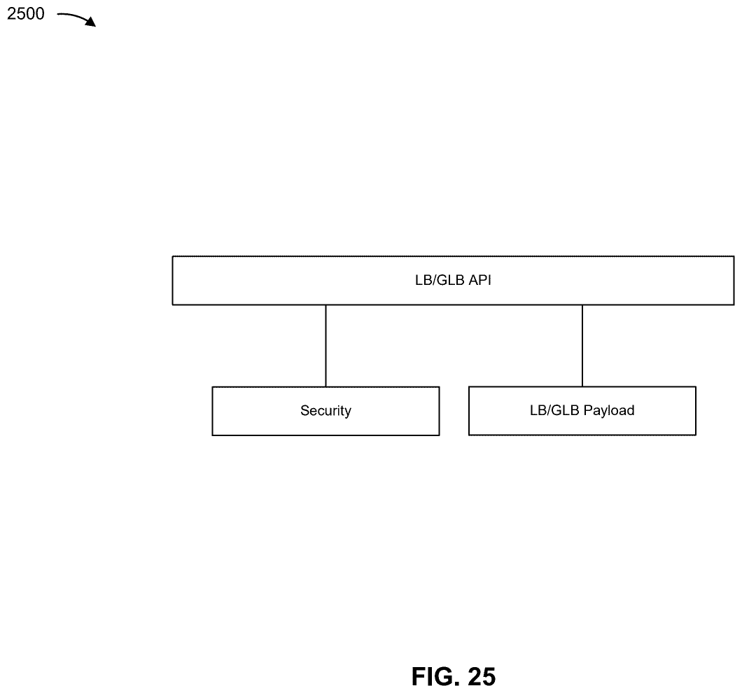

FIG. 25 is a diagram of an example 2500 associated with an LB or GLB (LB/GLB) API.

As shown in FIG. 25, the LB/GLB API may be associated with a security API and an LB/GLB payload. Operational APIs for an LB/GLB, which may be a cloud service component, may not be needed. Cloud service managed service operational (envelope) APIs may cover all cloud service components. The security API may be part of an LB/GLB payload, unless a WAF is ordered separately.

As indicated above, FIG. 25 is provided as an example. Other examples may differ from what is described with regard to FIG. 25.

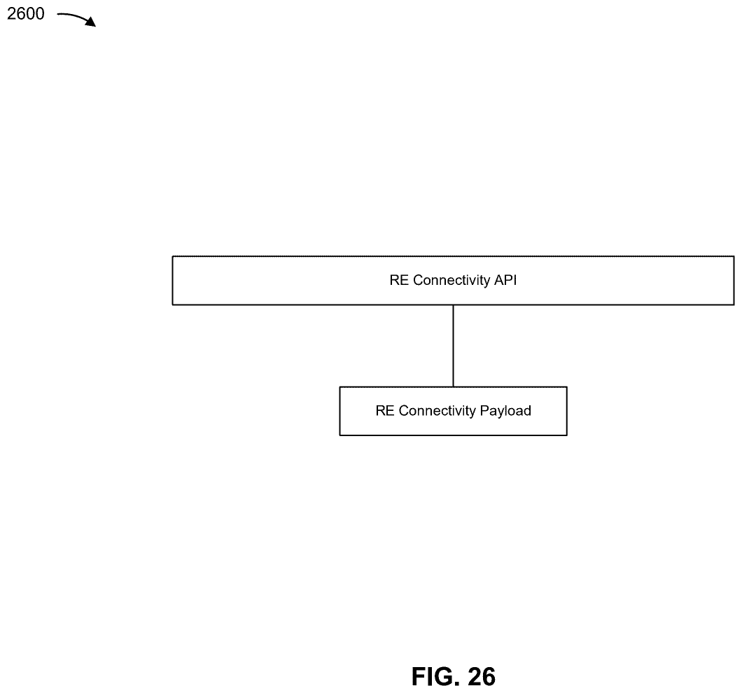

FIG. 26 is a diagram of an example 2600 associated with an RE connectivity API.

As shown in FIG. 26, the RE connectivity API may be associated with an RE connectivity payload. Operational APIs for an RE, which may be a cloud service component, may not be needed. Cloud service managed service operational (envelope) APIs may cover all cloud service components.

As indicated above, FIG. 26 is provided as an example. Other examples may differ from what is described with regard to FIG. 26.

In some implementations, operational APIs may be associated with a cloud service. A service order API or self-configuration API may configure a cloud UNI, a cloud application interface, and/or a cloud VC and its EPs. An inventory API may retrieve values and a status of all components of the cloud UNI, the cloud application interface, and/or the cloud VC and its EPs. A fault management API may generate notifications for failures or threshold crossing values of the cloud UNI, the cloud application interface, and/or the cloud VC and its EPs. The fault management API may retrieve logs for failures. A performance management API may retrieve periodic and on-demand measurement for a utilization cloud UNI, the cloud application interface, and/or the cloud VC (e.g., a delay, jitter, and/or loss associated with the cloud VC). A trouble ticketing API may create trouble tickets for failures of any cloud service component, and track a status of tickets. A dynamic service modification API may modify attribute values of the cloud UNI, the cloud application interface, the cloud VC, EPs, and other components, such as a CE, RE, or mesh network on demand such as a cloud VC bandwidth or QoS. A health service API may calculate a service health periodically and prepare for retrieval.

In some implementations, operational APIs may be associated with a CE. A service order API or self-configuration API may configure a CE cluster (e.g., processing, memory, and/or servers), add/remove servers, perform proxying, and/or apply a WAF and attach the WAF to a desired LB. An inventory API may retrieve values and a status of all components of the CE. A fault management API may generate notifications for failures or threshold crossing values of servers, connections, CE software, and/or security attacks. The fault management API may retrieve logs for failures. A performance management API may retrieve periodic and on-demand measurements for a utilization of processing, memory, and/or bandwidth with/without a graph.

In some implementations, operational APIs may be associated with a CE mesh network. A service order API or self-configuration API may configure a site mesh including connectivity (tunnels), connection security options. The service order API or self-configuration API may add or remove connections. An inventory API may retrieve values and a status of all components of a mesh network, including retrieval of a site connectivity graph. A performance management API may retrieve a periodic measurement for bandwidth utilization of connections with/without a graph. A fault management API may generate notifications for failures or threshold crossing values of connections, and/or security attacks. The fault management API may retrieve logs for failures.

In some implementations, operational APIs may be associated with an LB/GLB. A service order API or self-configuration API may configure algorithm options, such as round-robin, weighted least request, random, or ring-hash. An inventory API may retrieve values and a status of all components of an LB. A fault management API may generate notifications for failures of the LB and security attacks. The fault management API may retrieve logs for failures. A service health API may retrieve a service discovery and service health. A performance management API may retrieve a periodic measurement of application delay, jitter, and/or loss.

In some implementations, operational APIs may be associated with an RE. A service order API or self-configuration API may configure RE servers, a cloud virtual routing and forwarding (VRF), a customer VRF, RE software, and/or security capabilities supported by the RE such as BOTnet to protect against large-scale cyber-attacks. An inventory API may retrieve values and a status of all components of the RE. A fault management API may generate notifications for failures of RE servers and software and security attacks. The fault management API may retrieve logs for failures. A performance management API may retrieve a periodic measurement for port utilization with/without a graph.

In some implementations, operational APIs may be associated with a mesh network. A service order API or self-configuration API may configure a connectivity, and/or add/remove connections or security capabilities associated with the connections. An inventory API may retrieve values and a status of all components of the mesh network. The inventory API may retrieve a site connectivity graph. A fault management API may generate notifications for failures of connections. The fault management API may retrieve logs for failures. A performance management API may retrieve a periodic measurement for a bandwidth utilization of the connections. A trouble ticketing API may create trouble tickets for failures of the CE, the RE, the LB/GLB, and/or the mesh network. The trouble ticketing API may track a status of tickets.

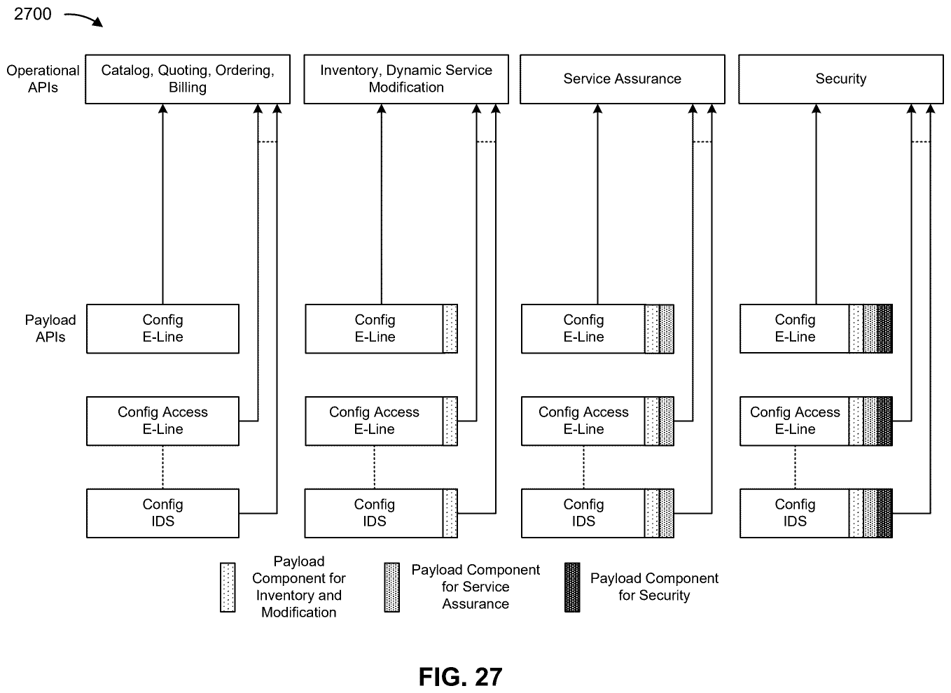

FIG. 27 is a diagram of an example 2700 associated with a relationship between operational APIs and payload APIs.

As shown in FIG. 27, in a first example, operational APIs may be associated with a catalog, quoting, ordering, and/or billing. Payload APIs may be associated with a configuration of services such as an Ethernet line (E-line), an access E-line, and/or an Internet Dedicated Service (IDS). In a second example, operational APIs may be associated with inventory and/or dynamic service modification. Payload APIs may be associated with configuration of services such as E-line, access E-line, and/or IDS. The configuration E-line, the configuration access E-line, and/or the configuration IDS may each be associated with a payload component for inventory and dynamic modification. In a third example, operational APIs may be associated with service assurance (e.g., FM and PM). Payload APIs may be associated with configuration of services such as E-line, access E-line, and/or IDS. The configuration E-line, the configuration access E-line, and/or the configuration IDS may each be associated with a payload component for inventory and modification and a payload component for service assurance. In a fourth example, operational APIs may be associated with security. Payload APIs may be associated with a configuration of services such as E-line, access E-line, and/or IDS. The configuration E-line, the configuration access E-line, and/or the configuration IDS may each be associated with a payload component for inventory and modification, a payload component for service assurance (e.g., FM and PM), and a payload component for security. Attributes of each service payload API for each type of operational API may slightly differ due to additional functionalities. For example, a configuration payload API may not have measurement related attributes that are required for a PM operational API. All attributes may be combined in a single payload API for a given service to accommodate all types of operational APIs.

As indicated above, FIG. 27 is provided as an example. Other examples may differ from what is described with regard to FIG. 27.

FIG. 28 is a diagram of an example 2800 associated with an SCI architecture.

As shown in FIG. 28, the SCI architecture may be associated with an underlay-volume connectivity. A first CPE may be connected to a PIP network via a first UNI. The first UNI may be connected to a primary ENNI EP via a primary IP connection that has one EP at UNI and another EP at ENNI which is equivalent to primary ENNI EP. The primary IP connection may be associated with a first SCI NAT which is an optional component. The first SCI NAT, which is part of ENNI capability, can be associated with the IP connection or primary SCI connection depending on the location of SCI NAT, The first CPE may be connected to a secondary ENNI EP via a secondary IP connection that has one EP at UNI and another EP at ENNI which is equivalent to secondary ENNI EP. The secondary IP connection may be associated with a second SCI NAT which is an optional component. The primary ENNI EP at PIP network port (e.g., connectivity operator port) may be connected, via a primary SCI connection, to a primary ENNI EP associated with a cloud operator network port. The primary SCI connection may be associated with a primary ENNI. The secondary ENNI EP at a PIP network port (e.g., connectivity operator port) may be connected, via a secondary SCI connection, to a secondary ENNI EP associated with the cloud operator network port. The secondary SCI connection may be associated with a secondary ENNI. Further, a second CPE may be connected to the PIP network via a second UNI, and sharing primary and secondary IP connections and primary and secondary SCI connections with the first UNI.

As indicated above, FIG. 28 is provided as an example. Other examples may differ from what is described with regard to FIG. 28.

FIG. 29 is a diagram of an example 2900 associated with an SCI architecture.

As shown in FIG. 29, the SCI architecture may be associated with an underlay-volume connectivity. A PIP network may be associated with a first cloud operator (cloud operator 1) and a second cloud operator (cloud operator 2). Connections between the PIP network and the first cloud operator may include a primary SCI1 connection, a primary cloud operator1—cloud operator2 connection, a secondary SCI1 connection, and a secondary cloud operator1—cloud operator2 connection, where the connections may be associated with redundant ENNIs. Connections between the PIP network and the second cloud operator may include a primary SCI2 connection and a secondary SCI2 connection, where the connections may be associated with redundant ENNIs. ENNIs may support NAT/FW capabilities.

As indicated above, FIG. 29 is provided as an example. Other examples may differ from what is described with regard to FIG. 29.

FIG. 30 is a diagram of an example 3000 associated with an SDI architecture for an L2 transport.

As shown in FIG. 30, the SDI architecture for the L2 transport may be associated with a single VRF. A CPE may be connected to an L2 network via an E-line Ethernet virtual connection (EVC) over an Ethernet PHY link. The L2 network may include a first provider edge (PE) router and a second PE router for redundancy. The CPE may be connected to the first PE via one or more E-line EVCs, which may be associated with a primary cloud operator connection (or primary customer connection). The CPE may be connected to the second PE via one or more E-line EVCs, which may be associated with a secondary cloud operator connection (or secondary customer connection). The first PE may be connected to carrier hotel infrastructure via an Ethernet local area network (E-LAN) over a primary ENNI instead of a point-to-point EVC. The primary ENNI may be associated with a primary ENNI connection. The second PE may be connected to the carrier hotel infrastructure via an E-LAN over a secondary ENNI. The secondary ENNI may be associated with a secondary ENNI connection. The carrier hotel infrastructure may be connected to a cloud operator via one or more E-LAN EVCs, which may be associated with one or more primary cloud operator connections. E-LAN provides real-time communications between primary and secondary ENNIs. E-LAN on the cloud operator side provides real-time communications between primary and secondary cloud operator routers (PEs).

As indicated above, FIG. 30 is provided as an example. Other examples may differ from what is described with regard to FIG. 30.

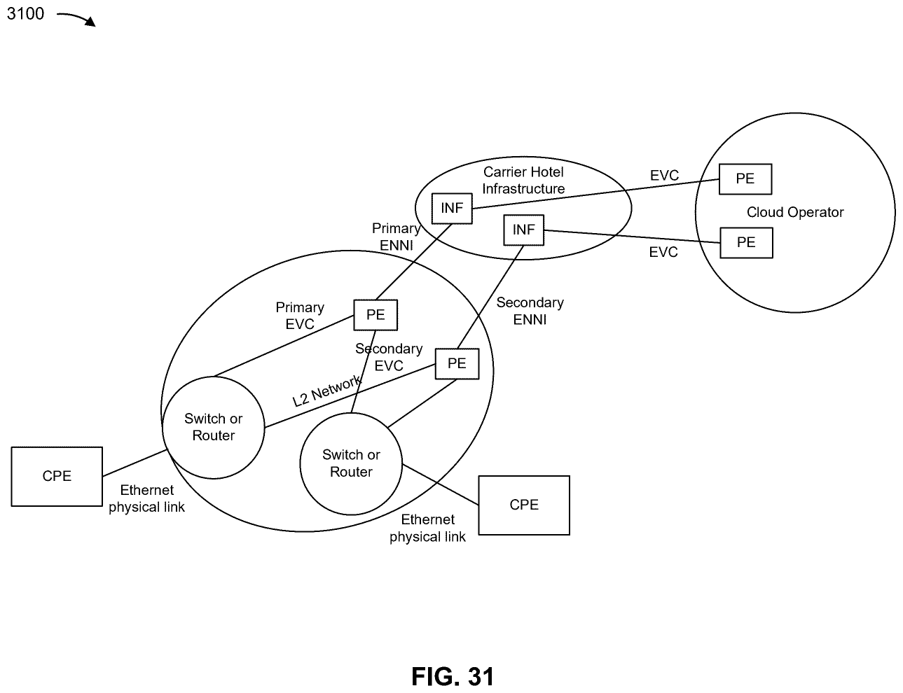

FIG. 31 is a diagram of an example 3100 associated with an SDI architecture for an L2 transport.

As shown in FIG. 31, the SDI architecture for the L2 transport may be associated with multiple VRFs. A first CPE may be connected to an L2 network via a first Ethernet PHY link. The first CPE may be connected to a first PE and a second PE via a primary EVC and a secondary EVC, respectively. A second CPE may be connected to the L2 network via a second Ethernet PHY link. The second CPE may be connected to the first PE and the second PE via a primary EVC and a secondary EVC, respectively. The first PE may be connected to a carrier hotel infrastructure via a primary ENNI (SDI access). The second PE may be connected to the carrier hotel infrastructure via a secondary ENNI (SDI access). The carrier hotel infrastructure may be connected to a cloud operator via one or more EVCs. In this configuration, traffic belongs to multiple VRFs ride over the same primary and secondary ENNIs.

As indicated above, FIG. 31 is provided as an example. Other examples may differ from what is described with regard to FIG. 31.

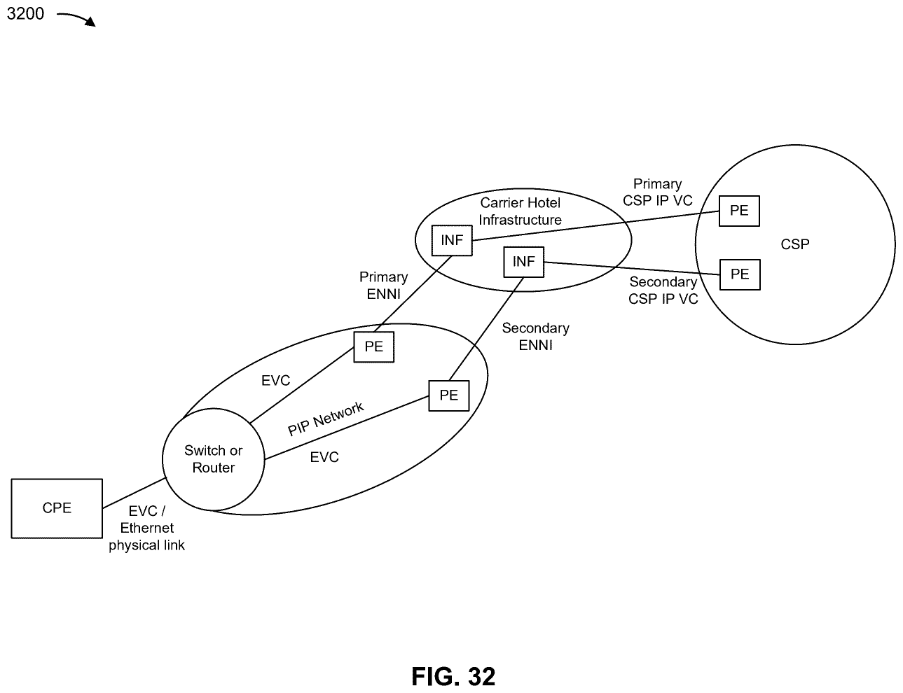

FIG. 32 is a diagram of an example 3200 associated with an SDI architecture for an L3 transport.

As shown in FIG. 32, in the SDI architecture for the L3 transport, a CPE may be connected to a PIP network via an EVC over an Ethernet PHY link. The PIP network may include a first PE and a second PE. The CPE may be connected to the first PE via one or more EVCs, which may be associated with a primary customer connection and/or a primary IP VC. The CPE may be connected to the second PE via one or more EVCs, which may be associated with a secondary customer connection and/or a secondary IP VC. The first PE may be connected to a carrier hotel infrastructure via an IP VC over a primary ENNI. The second PE may be connected to the carrier hotel infrastructure via an IP VC over a secondary ENNI. The carrier hotel infrastructure may be connected to a cloud operator via a primary cloud operator IP VC and a secondary cloud operator IP VC.

As indicated above, FIG. 32 is provided as an example. Other examples may differ from what is described with regard to FIG. 32.

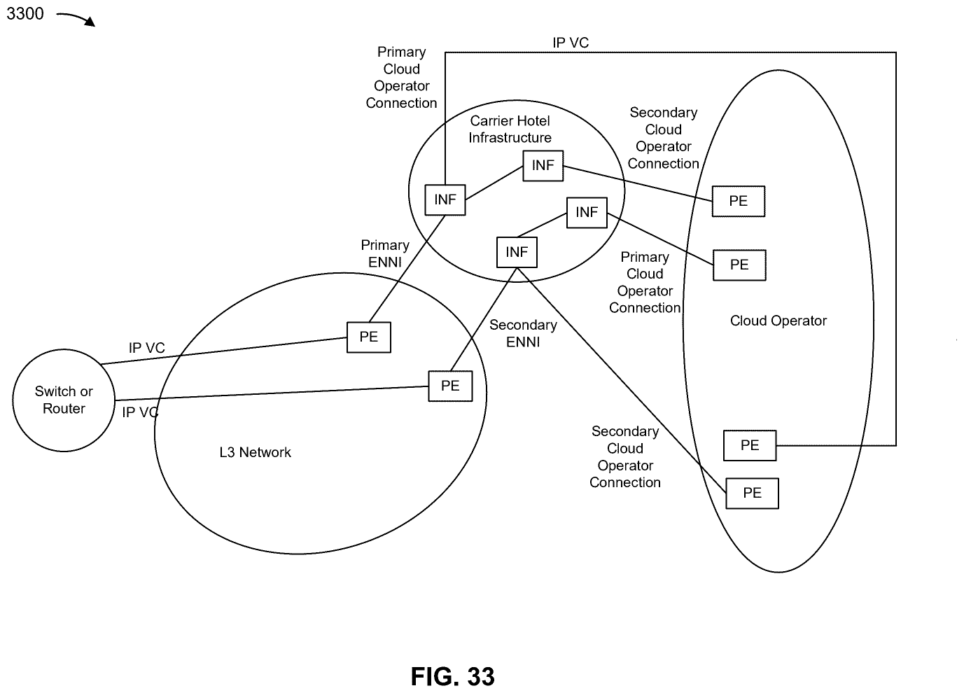

FIG. 33 is a diagram of an example 3300 associated with an SDI architecture for an L3 network.

As shown in FIG. 33, in the SDI architecture for the L3 network, a switch or router may be connected to a first PE and a second PE in the L3 network for redundancy. The switch or router may be connected to the first PE and the second PE via IP VCs. The first PE may be connected to a carrier hotel infrastructure via a primary ENNI and an IP VC. The second PE may be connected to the carrier hotel infrastructure via a secondary ENNI and an IP VC. The carrier hotel infrastructure may be connected to one or more PEs associated with a cloud operator via one or more primary cloud operator connections and one or more secondary cloud operator connections, where each of the one or more primary cloud operator connections and the one or more secondary cloud operator connections may be associated with an IP VC.

As indicated above, FIG. 33 is provided as an example. Other examples may differ from what is described with regard to FIG. 33.

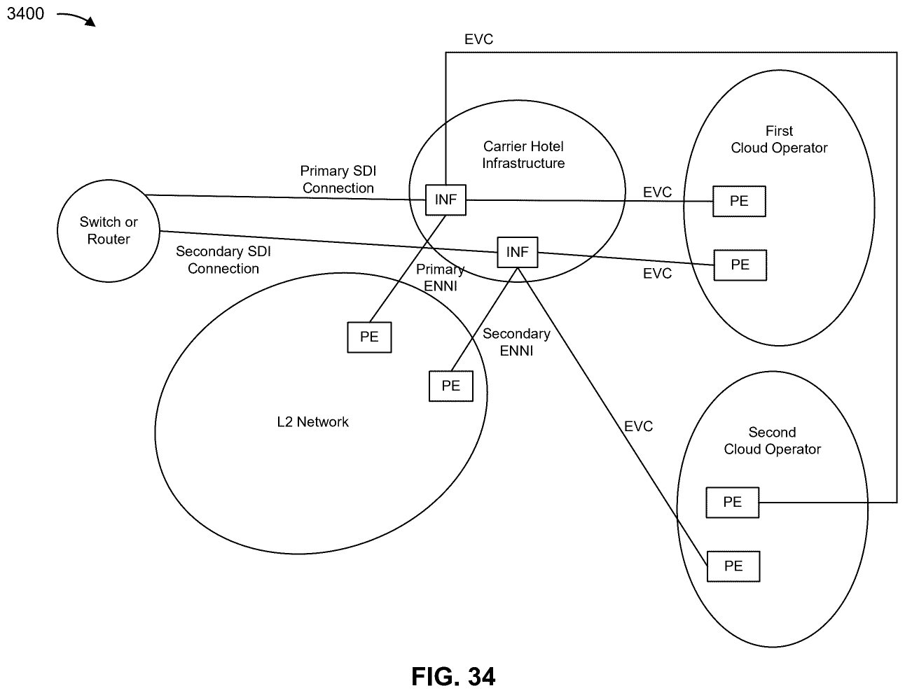

FIG. 34 is a diagram of an example 3400 associated with an SDI architecture for an L2 transport.

As shown in FIG. 34, in the SDI architecture for the L2 network, a switch or router may be connected to a infrastructure. The switch or router may be connected to the carrier hotel infrastructure via a primary SDI connection and an EVC. The switch or router may be connected to the carrier hotel infrastructure via a secondary SDI connection and an EVC. A first PE in the L2 network may be connected to the carrier hotel infrastructure via a primary ENNI and an EVC. A second PE in the L2 network may be connected to the carrier hotel infrastructure via a secondary ENNI and an EVC. The infrastructure may be connected, via one or more EVCs, to one or more PEs associated with a first cloud operator and one or more PEs associated with a second cloud operator.

As indicated above, FIG. 34 is provided as an example. Other examples may differ from what is described with regard to FIG. 34.

In some implementations, an SCI service may be associated with an underlay-volume connectivity. The SCI service may be a service for users to access a software as a service (SaaS), a platform as a service (PaaS), and/or an infrastructure as a service (IaaS) provided by cloud operators over a private network, such as a PIP network, instead of a public network. For accessing the SaaS and/or the PaaS provided by the cloud operators, the private network may perform IP NAT services to each subscribing virtual private network (VPN). The private network may perform the IP NAT services to ensure that private network user hosts appear to originate from a uniquely routable IP address and not from an address used by another private network user (e.g., from a private address space). A baseline FW or NAT may be provided that cross-connects users with desired cloud operators. For accessing the IaaS provided by the cloud operators, an NAT may not be necessary since addresses may generally be supported by the IaaS. An SCI NAT may provide connections between a user's VPN and only desired cloud provider VPNs. Users may select from a variety of committed consumption plans or flexible plans. Multiple connections may be aggregated into a single data plan offering cost savings and flexibility.

In some implementations, an SDI service may be associated with an underlay-bandwidth connectivity. As part of an SDI, one or more PHY L2/L3 capable devices may be deployed in a number of data centers (e.g., carrier hotel infrastructures) across the world. Direct 10 to 100 gigabits per second (Gbit/s) cross-connects may be configured between the devices and the carrier hotel infrastructure, which may be a primary/secondary fabric for redundancy. An L2/L3 network may be extended to other cloud providers or user CPEs that are connected to the infrastructure. Rather than dedicated GWs, the carrier hotel infrastructure may be used to connect private networks to cloud operators. In some implementations, when an organization is to connect to a cloud operator with an SDI, an SDI access may be software configured on co-located devices and then attached to a user's PIP VPN or the user's E-line EVC or E-LAN EVC on one side and to one or more cloud operator routers on the other side. The SDI access may be attached to the user's PIP VPN when L3 is used, or the SDI access may be attached to the user's E-line EVC or E-LAN EVC when L2 is used. When L3 is used, a service provider (e.g., a cloud service provider) may manage a border gateway protocol (BGP) session between the SDI access and the one or more cloud operator routers. A logical SDI access may be used to route traffic between two entities. When L2 is used, the service provider may provide only a medium to connect organization routers to the one or more cloud operator routers, and the organization may be responsible for initiating and managing the BGP session with the one or more cloud operator routers.

In some implementations, a cloud-to-cloud (C2C) networking may be a capability of an application deployed in one cloud operator environment to communicate with one or more other applications deployed in different cloud operator environments. A bandwidth connectivity may guarantee dedicated bandwidths at preset speeds.

In some implementations, in a C2C network, while transferring data to cloud operators (e.g., ingress data) is typically free, data charges for transferring data out from cloud providers (e.g., egress data) may not be free. Cloud operators may charge more for egress data over their Internet GWs versus a private connection. An SDI may be a private network alternative for the connection to the cloud. In some implementations, a CSP may provide a mechanism (e.g., DC) to connect to their environment in a private manner without exposing traffic and applications to the public Internet. With this type of connection, the cloud operator may require an L2 (Ethernet) based connection, over which a BGP routing may be used. In some implementations, one cloud operator may be connected to another cloud operator directly over an L2 connection, but such a direct connectivity may not be possible due to an incompatibility of BGP parameters between two cloud operators, an incompatibility of IP addressing between cloud operators, an incompatibility of virtual local area network (VLAN) tag usage, and/or an inability of supporting multiple BGP sessions. In some implementations, enterprises may opt to use a private connection alternative from the cloud operator (e.g., DC). In this case, a private network may be required to connect enterprise remote locations to that cloud operator private connection. A multiprotocol label switching (MPLS) backbone may serve as the private network. An SDI may connect an MPLS network to a private construct from the cloud provider. In some implementations, the C2C network may be used to connect the organization's remote users/locations to cloud-hosted applications.

In some implementations, infrastructure fabric users may create a virtual connection to a PIP network. An access to the PIP network may be a service-provider-ordered access or a user-ordered access. The service-provider-ordered access may be delivered through a service provider PIP API or portal. The user-ordered access may be ordered through an infrastructure fabric portal. To enable connections to the PIP network over the infrastructure fabric, the service provider may use an SDI based workflow API. In the SDI based workflow API, a user may access the infrastructure fabric portal and create/configure a connection to a service provider PIP. The user may either log into the service provider PIP portal or access a self-configuration API and create an L2 connection. The user may enter an authorization key assigned from the infrastructure fabric API or portal. The service provider may accept the connection via an SDI API.

In some implementations, a cloud UNI for the cloud service with both underlay and overlay components may be application aware due to a VC application awareness. Otherwise, the application awareness, e.g., application level protocol, may be supported by a CPE behind a UNI. A UNI may be associated with a PHY layer and redundant. An application interface may be a CE interface to applications, where the application interface may include a WAF and/or an LB. If the service is only underlay, a UNI is not aware of the application. In the cloud service with both underlay and overlay components may be VC application aware, where an application quality of service (QoS) may be mapped into a VC QoS, and a VC bandwidth may be calculated based on requests per second (RPS) or calls per second (CPS) of the application. VC may be redundant, and supporting routing protocols such as BGP, a maximum transmission unit (MTU), a list of EPs, and so on. The VC may be point-to-point or multipoint. A VC EP may be a logical entity at a UNI or application interface acting as a hub or spoke, to which a particular subset of packets that traverse the external interface (EI) (e.g., UNI, ENNI, or application interface) may be mapped. The particular subset of packets may be identified by a packet field (e.g., a source IP address and/or a destination IP address). The packet field may be associated with a prefix mapping, a bandwidth profile, and/or the MTU. An ENNI may be a combination of underlay and overlay ENNIs between connectivity operator and cloud operators, or between cloud operators, supporting L2, L3, or L3 plus L7 protocols.

In some implementations, the underlay APIs may be associated with connectivity and security services from a CPE to a cloud operator GW, which may be based on an SCI, and a PIP network, or based on an SDI and the PIP network. The underlay APIs may be associated with a volume connectivity, which may be based on the SCI and the PIP network. The volume connectivity, which is a usage based service, may be associated with UNI, which is not application-aware when the connectivity and security service is only an underlay. The volume connectivity may be associated with an L3 ENNI, a routing protocol such as BGP, IP addressing, and/or NAT/FW. The volume connectivity may be associated with VC which is not application aware when the connectivity and security service is only the underlay. The volume connectivity may be associated with VC EPs acting as a spoke (leaf) or hub (root), mapping prefixes to a VC (IP range and subnet mask) indicating which IP prefixes can send and receive traffic to/from a cloud VC, L2 addressing for an EP at a UNI (C-Tag), a maximum number of IPv4/IPv6 routes, route filtering (community filtering or route summarization), an ingress/egress class of Service map, a differential services code point (DSCP) code for QoS, and an ingress/egress bandwidth profile (e.g., CIR, MaxIR, etc.). The underlay APIs may be associated with a bandwidth connectivity, which may be based on the SDI and the PIP network. The bandwidth connectivity, which may be based on the size of bandwidth, may be associated with UNI-not-application-aware when the connectivity and security service is only the underlay. The bandwidth connectivity may be associated with an L2 ENNI. The bandwidth connectivity may be associated with VC-not-application-aware when the connectivity and security service is only the underlay. The bandwidth connectivity may be associated with VC EPs acting as a spoke (leaf) or hub (root), mapping prefixes to a VC (IP range and subnet mask) indicating which IP prefixes can send and receive traffic to/from a cloud VC, L2 addressing for an EP at a UNI (C-Tag), a maximum number of IPv4/IPv6 routes, route filtering (community filtering or route summarization), an ingress/egress class of service map, a DSCP code for QoS, and ingress/egress bandwidth profile (e.g., CIR, MaxIR, etc.).

In some implementations, the overlay APIs may be associated with connectivity, security, and LB services among applications. The overlay APIs may be associated with a mesh network, which may be a network among virtual sites including a full mesh of tunnels. The mesh network may be associated with an application interface. The application interface may be a CE interface with a WAF and an LB. The mesh network may be associated with an ENNI, a routing protocol such as BGP, IP addressing, NAT/FW, and/or WAF/GLB. The mesh network may be associated with VCs. The mesh network may be associated with VC EPs. The VC EPs may be associated with a prefix matching, which may define which IP prefixes can send/receive traffic to/from a VC. The mesh network may be associated with L2 addressing, a maximum number of routes, community filtering/route summarization, a DSCP code or priority codepoint (PCP) code for QoS, and/or an ingress/egress bandwidth profile. The mesh network may be associated with a mesh network type (e.g., hub mesh, spoke mesh, or full mesh). The mesh network may be associated with a list of master nodes and a list of worker nodes. The mesh network may include an RE, which may act as a hub among CEs and support community filtering for CSPs to handle route limitations. The mesh network may be associated with volume connectivity and bandwidth connectivity GWs (e.g., SCI and SDI). The mesh network may be associated with a tunnel type, such as IP security (IPSec), secure sockets layer (SSL), or generic routing encapsulation (GRE). In some cases, the mesh network may not include the RE, and/or the volume connectivity and bandwidth connectivity GWs (e.g., SCI and SDI). Instead, CEs may be connected via IPSec or SSL tunnels provided by cloud operators (e.g., CE mesh).

In some implementations, the overlay APIs may be associated with a CE (e.g., for self-management by a customer). The CE may be associated with interface types, such as static IP version 4 (IPv4) or IP version 6 (IPv6), or a dynamic host configuration protocol (DHCP) client/server. The CE may be associated with a local network, a storage network, a VLAN choice (e.g., tagged or untagged), a VLAN ID, a node choice (e.g., cluster or node), and/or a loopback interface. The CE may be associated with a list of domain name system (DNS) load balancers, a list of hypertext transfer protocol (HTTP) load balancers, and/or a list of transmission control protocol (TCP) load balancers. The CE may be associated with redundancy.

In some implementations, the overlay APIs may be associated with an RE (e.g., a WAF and/or GLB configuration), which may provide connectivity to multiple cloud operators. An RE port bandwidth may take a management connection bandwidth into account. A WAF may involve whitelisting or blocking certain IP addresses or uniform resource locators (URLs). The WAF may involve allowing or disallowing certain cookies. The WAF may involve limiting a size of uploading or downloading files. The WAF may involve protecting against session hijacking and cross site request forgery (CSRF). The WAF may involve supporting community filtering to handle cloud operator route limitations. The WAF may protect against buffer overflows, cookie poisoning, web scraping, structured query language (SQL) injection, parameter tampering, cross-site scripting, and/or brute force attacks. The RE may involve supporting a GLB, which may be based on a DNS.

In some aspects, LB/GLB load balancing across multiple application instances may be deployed for optimizing a resource utilization, maximizing a throughput, reducing a latency, and/or ensuring fault tolerant configurations. The LB/GLB load balancing may be associated with an HTTP connection limit (maximum number) to establish to all hosts in an upstream cluster, a maximum number of requests that can be outstanding to all hosts in a cluster at any given time, and/or a routing priority for each request. The LB/GLB load balancing may be associated with a TCP or user datagram protocol (UDP) transport layer security (TLS) protocol version, such as TLS_AUTO, TLSv1_0, or TLSv1_1/2/3. The LB/GLB load balancing may be associated with custom chippers, such as TLS_AES_128_GCM_SHA256, TLS_AES_256_GCM_SHA384, TLS_CHACHA20_POLY1305_SHA256. The LB/GLB load balancing may be associated with an origin pool priority and weight. The LB/GLB load balancing may be associated with listen port ranges for the LB (e.g., 0 and 65535). The LB/GLB load balancing may be associated with a list of domains (e.g., host/authority header) that will be matched to the LB. The LB/GLB load balancing may be associated with a list of hash policies (e.g., least active, random, or round robin). The LB/GLB load balancing may be associated with the DNS, where 4-byte autonomous system (AS) numbers may be used to allow/deny lists for network policy or service policy for a DNS load balancer, an IP prefix match list, and/or a location proximity policy.

In some implementations, a UNI may be associated with a PHY port, routing protocols, a maximum service frame size or IP MTU, a maximum number of EVC EPs or IP VC EPs, and/or a maximum number of VLAN IDs per EVC EP.

In some implementations, an application interface may be associated with an interface uplink/downlink bandwidth, routing protocols, an application awareness (e.g., true or false), an application egress policy, an application ingress policy, an application priority, an application priority to DSCP mapping, a number of simultaneous VCs supported, an origin pool that contains a public IP and server port for an application, and/or an origin pool redundancy. In some implementations, the origin pool redundancy may be active with passive failover. In this example, an LB with two origin pools (e.g., a primary origin pool and a secondary origin pool) may be created. The LB may direct all traffic to the primary origin pool until the primary origin pool has fewer available origins than specified in its health threshold, and then the LB may direct traffic to the secondary origin pool. In some implementations, the origin pool redundancy may be active with active failover. In this example, traffic may be distributed to servers in the same origin pool until the origin pool reaches its failure threshold which is configurable. To set up an LB with active-active failover, the LB may be created with a single origin pool with multiple origins (e.g., origin-1 and origin-2) and the same weight may be set for each origin.

In some implementations, a cloud VC EP may be associated with an EP role (e.g., leaf, root, or trunk). The EP role may also include a spoke (leaf) or hub (root or trunk). The cloud VC EP may be associated with an EP prefix mapping (e.g., an IP range and subnet mask), where the EP prefix mapping may indicate which IP prefixes can send and receive traffic to/from an IP VC. The cloud VC EP may be associated with L2 addressing for an EP at a UNI (e.g., C-Tag). The cloud VC EP may be associated with L2 addressing for an EP at an application interface (e.g., S-Tag and C-Tag). The cloud VC EP may be associated with an EP maximum number of IPv4 routes. The cloud VC EP may be associated with route filtering (e.g., community filtering such as 65000:8000, or route summarization). The cloud VC EP may be associated with an EP ingress/egress class of service map. The cloud VC EP may be associated with a DSCP code for QoS. The cloud VC EP may be associated with an ingress/egress bandwidth profile.

In some implementations, a cloud VC may be associated with a VC topology (e.g., point-to-point, or multipoint), a list of EPs, a maximum number of IPV4/v6 routes, DSCP (differentiated services code points) preservation, an MTU, path MTU discovery, packet fragmentation, an ingress/egress QoS map, a VC tunnel type (e.g., IPSec, SSL, or GRE), IPSec tunnel encapsulation (e.g., IPSec public key infrastructure (PKI) or IPSec pre-shared key (PSK)), an NAT, redundancy, a list of IP prefixes, and/or a service provider network VLAN (S-VLAN or S-Tag) ID and associated customer network VLAN (C-VLAN) IDs.

In some implementations, a cloud ENNI (e.g., an L3 ENNI) may be associated with an ENNI PHY layer (e.g., 1000BASE-T Ethernet), bidirectional forwarding detection (BFD) support on an ENNI link, an ENNI link IP MTU (e.g., a maximum size, in octets, of an IP packet that can traverse the cloud ENNI), and/or an ingress/egress bandwidth per sub interface. In some implementations, the cloud ENNI may be associated with an IPV4/v6 connection addressing type per link (none or static), a local autonomous system number (ASN) (for an SP or connectivity operator) and a remote ASN (for a cloud operator), an outbound NAT IP address, a white list public ASN, supported IP and control protocols at the cloud ENNI (e.g., BGP or Internet Control Message Protocol (ICMP)), maximum routes for the SP and the cloud operator, and/or NAT/FW attributes. The NAT/FW attributes may include a network access control list (ACL) of rules that either allow access to the cloud operator or the SP/connectivity operator or deny the access, an NAT type (e.g., private peering, public peering, or shared public peering), and/or a number of sessions per NAT IP.

In some implementations, the cloud ENNI may be associated with a BGP peering type. In a first option, a separate BGP session may be used across each ENNI link, and each session may carry routes for one service. One PHY is per customer. In a second option, one or more BGP sessions may be used across the cloud ENNI, where each BGP session exchanges labelled VPN routes for multiple services. The routes for different services may be distinguished by attributes, such as route distinguishers (RDs) or route targets (RTs), which may result in IP packets across the cloud ENNI being encapsulated in L2, where IP packets for different services may have different VLAN IDs. Each packet may have a single VLAN ID that identifies both an egress PE and a service. In a third option, one or more BGP sessions may be used across the cloud ENNI only to distribute labelled unicast routes (and VLAN IDs) toward each cloud operator's own routers.

In some implementations, a cloud ENNI (e.g., L2 ENNI) may be associated with a dedicated or shared PHY layer (e.g., 1 Gbps, 10 Gbps, or 100 Gbps), a frame format, a number of physical links, a protection mechanism between links, link aggregation, an MTU (e.g., a maximum length ENNI frame in bytes allowed at the cloud ENNI), a maximum number of EVCs, a maximum number of EVC EPs, link operations, administration, and management (OAM) at each link, a user authentication key for the cloud operator, and/or an ENNI port priority.

In some implementations, a CE may be associated with a hosting cloud operator, a CE cluster location, a master node on site, a site address mode (e.g., static or DHCP), a site central processing unit (CPU) or general processing unit (GPU) size, a site memory size, and/or BGP peering information (e.g., an address family or a BGP peer ID).

In some implementations, an RE may store keys, decrypt traffic, proxy, and/or apply other application delivery and security features on a per-application basis. The RE may use its own routing and Internet breakout to check a reachability of an application. The RE may employ a health check to monitor the application and confirm whether the application is accessible by simulating normal user traffic (e.g., HTTP traffic) and checking a performance metric. The RE may provide distributed denial-of-service (DDoS) attack protection to protect a network from an attacker flooding a server with Internet traffic, which may prevent users from accessing connected online services and sites. A rate limiting may be provided by a GLB (TCP, HTTP, or DNS). An API discovery may be provided by the GLB. The RE may provide bot protection, where such a capability may protect from malicious bots and ensure an integrity and availability of online resources, without impacting good bots that help facilitate online commerce. Further, the RE may be associated with an SSL termination and an IPSec termination.

In some implementations, one or more APIs may provide user devices with an ability to interact with a server-side of an application. For example, a client may use APIs to send a GET request to retrieve data from a server. The server may process the GET request according to pre-defined functions and respond to the client with application data. Each API request that provides functionality for users may expose API endpoints that have become a target for attackers. An API security function may ensure secure API exchanges among users and applications.

In some implementations, a cloud service health may be based on a first approach or a second approach. In the first approach, a cloud service health per user location may be based on a health of a UNI, a health of an application interface, a health of a cloud VC, and/or a health of cloud VC EPs. The cloud service health may equal 1 (e.g., 100%) when no degradation and/or failure is present (e.g., no threshold crossing alert (TCA) or service level agreement (SLA) violation). The cloud service health may equal 0 when a failure is present. The cloud service health may equal 0.5 (e.g., 50%) when a threshold is exceeded, which may be a user settable parameter. The cloud service health per user may be based on a summation of a health of each user location divided by a total number of user locations. In the second approach, the cloud service health per user location may be based on a health of an underlay and a health of an overlay. The cloud service health per user may be based on a summation of a health of each customer location divided by a total number of user locations.

In some implementations, an underlay service health may be defined. A volume connectivity service health per user location may be based on a health of an underlay UNI, a health of an IP connection between a CPE and RE port, a health of an RE port, a health of an IP connection between an RE and an SCI, and/or a health of the SCI. A volume connectivity service health per user may be based on a summation of a health of each volume connectivity user location divided by a total number of user locations. A bandwidth connectivity service health per user location may be based on a health of an underlay UNI, a health of an IP connection between the CPE and RE port, a health of the RE port, a health of an IP connection between the RE and an SDI, and/or a health of the SDI. A bandwidth connectivity service health per user may be based on a summation of a health of each volume connectivity user location divided by a total number of user locations. An underlay service health per user may be based on a volume connectivity service health per user and a bandwidth connectivity service health per user. In an L3 plus L7 connectivity which is part of an overlay, a health of an LB and a WAF supported by the RE may be included in a health of the RE, or may be considered as separate components. In that case, the health of the RE may be based on a health of basic RE hardware/software for an underlay, and a health of the LB, and a health of the WAF for the overlay.

In some implementations, an overlay service health may be based on a first approach or a second approach. In the first approach, an overlay service health per user location connected to an overlay may be based on a health of application interfaces, a health of a cloud VC, and/or a health of cloud VC EPs. A cloud service overlay service health per user may be based on a summation of a health of each user location connected to an overlay divided by a total number of user locations. In the second approach, an overlay service health per user location connected to the overlay may be based on a health of CEs supporting a cloud service connection in a mesh network, a health of the cloud VC within the mesh network, and/or a health of RE ports supporting the cloud service connection. In an L3 plus L7 connectivity, a health of an LB and a WAF supported by an RE may be included in a health of the RE and a CE, respectively, or may be considered as separate components. In that case, a health of the RE may be based on a health of a basic RE hardware/software, a health of the LB, and/or a health of the WAF. A health of the CE may be based on a health of basic CE hardware/software, the health of the LB, and/or the health of the WAF.

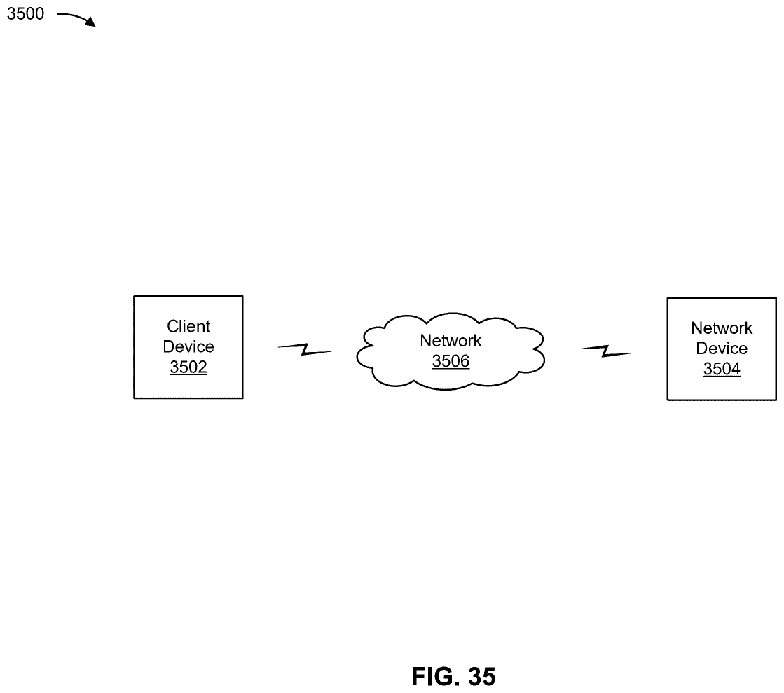

FIG. 35 is a diagram of an example environment 3500 in which systems and/or methods described herein may be implemented. As shown in FIG. 35, environment 3500 may include a client device 3502, a network device 3504, and a network 3506. Devices of environment 3500 may interconnect via wired connections, wireless connections, or a combination of wired and wireless connections. Devices or components of environment 3500 may provide various networking and/or security functionalities.

The client device 3502 may include one or more devices capable of receiving, generating, storing, processing, and/or providing information associated with APIs associated with cloud services, as described elsewhere herein. The client device 3502 may include a CPE. The client device 3502 may include a communication device and/or a computing device. For example, the client device 3502 may include a wireless communication device, a mobile phone, a laptop computer, a tablet computer, a desktop computer, a gaming console, a set-top box, a wearable communication device (e.g., a smart wristwatch, a pair of smart eyeglasses, a head mounted display, or a virtual reality headset), a smart television, an Internet of Things (IoT) device, or a similar type of device. The client device 3502 may include a modem, a router, a switch, a wireless access point, or other networking equipment.

The network device 3504 may include one or more devices capable of receiving, generating, storing, processing, and/or providing information associated with APIs associated with cloud services, as described elsewhere herein. The network device 3504 may be an API GW, an RE, an SCI GW, an SDI GW, a DC GW, an infrastructure GW, and/or a CE. In some implementations, the network device 3504 may include a router, such as an ingress router, an egress router, a provider router (e.g., a provider edge router or a provider core router), a virtual router, or another type of router. The network device 3504 may include a GW such as an API GW, a switch, a firewall, a hub, a bridge, a reverse proxy, a server (e.g., a proxy server, a cloud server, or a data center server), a load balancer, and/or a similar device. In some implementations, the network device 3504 may be a virtual device implemented by one or more computing devices of a cloud computing environment or a data center. In some implementations, a group of network devices 3504 may be a group of data center nodes that are used to route traffic flow through a network.

The network 3506 may include one or more wired and/or wireless networks. For example, the network 3506 may include a cellular network (e.g., a Sixth Generation (6G) network, a Fifth Generation (5G) network, a Fourth Generation (4G) network, a Long Term Evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 3506 enables communication among the devices of environment 3500.

The number and arrangement of devices and networks shown in FIG. 35 are provided as an example. In practice, there may be additional devices and/or networks, fewer devices and/or networks, different devices and/or networks, or differently arranged devices and/or networks than those shown in FIG. 35. Furthermore, two or more devices shown in FIG. 35 may be implemented within a single device, or a single device shown in FIG. 35 may be implemented as multiple, distributed devices. Additionally, or alternatively, a set of devices (e.g., one or more devices) of environment 3500 may perform one or more functions described as being performed by another set of devices of environment 3500.

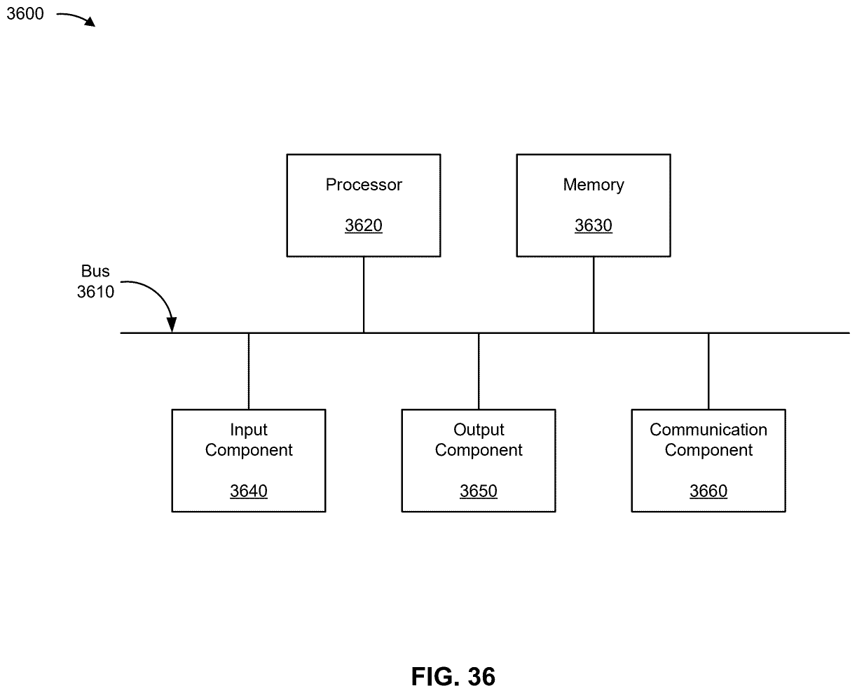

FIG. 36 is a diagram of example components of a device 3600 associated with APIs associated with cloud services. The device 3600 may correspond to a device (e.g., client device 102 or API GW 104). In some implementations, the network device may include one or more devices 3600 and/or one or more components of the device 3600. As shown in FIG. 36, the device 3600 may include a bus 3610, a processor 3620, a memory 3630, an input component 3640, an output component 3650, and/or a communication component 3660.

The bus 3610 may include one or more components that enable wired and/or wireless communication among the components of the device 3600. The bus 3610 may couple together two or more components of FIG. 36, such as via operative coupling, communicative coupling, electronic coupling, and/or electric coupling. For example, the bus 3610 may include an electrical connection (e.g., a wire, a trace, and/or a lead) and/or a wireless bus. The processor 3620 may include a central processing unit, a graphics processing unit, a microprocessor, a controller, a microcontroller, a digital signal processor, a field-programmable gate array, an application-specific integrated circuit, and/or another type of processing component. The processor 3620 may be implemented in hardware, firmware, or a combination of hardware and software. In some implementations, the processor 3620 may include one or more processors capable of being programmed to perform one or more operations or processes described elsewhere herein.

The memory 3630 may include volatile and/or nonvolatile memory. For example, the memory 3630 may include random access memory (RAM), read only memory (ROM), a hard disk drive, and/or another type of memory (e.g., a flash memory, a magnetic memory, and/or an optical memory). The memory 3630 may include internal memory (e.g., RAM, ROM, or a hard disk drive) and/or removable memory (e.g., removable via a universal serial bus connection). The memory 3630 may be a non-transitory computer-readable medium. The memory 3630 may store information, one or more instructions, and/or software (e.g., one or more software applications) related to the operation of the device 3600. In some implementations, the memory 3630 may include one or more memories that are coupled (e.g., communicatively coupled) to one or more processors (e.g., processor 3620), such as via the bus 3610. Communicative coupling between a processor 3620 and a memory 3630 may enable the processor 3620 to read and/or process information stored in the memory 3630 and/or to store information in the memory 3630.

The input component 3640 may enable the device 3600 to receive input, such as user input and/or sensed input. For example, the input component 3640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 3650 may enable the device 3600 to provide output, such as via a display, a speaker, and/or a light-emitting diode. The communication component 3660 may enable the device 3600 to communicate with other devices via a wired connection and/or a wireless connection. For example, the communication component 3660 may include a receiver, a transmitter, a transceiver, a modem, a network interface card, and/or an antenna.

The device 3600 may perform one or more operations or processes described herein. For example, a non-transitory computer-readable medium (e.g., memory 3630) may store a set of instructions (e.g., one or more instructions or code) for execution by the processor 3620. The processor 3620 may execute the set of instructions to perform one or more operations or processes described herein. In some implementations, execution of the set of instructions, by one or more processors 3620, causes the one or more processors 3620 and/or the device 3600 to perform one or more operations or processes described herein. In some implementations, hardwired circuitry may be used instead of or in combination with the instructions to perform one or more operations or processes described herein. Additionally, or alternatively, the processor 3620 may be configured to perform one or more operations or processes described herein. Thus, implementations described herein are not limited to any specific combination of hardware circuitry and software.

The number and arrangement of components shown in FIG. 36 are provided as an example. The device 3600 may include additional components, fewer components, different components, or differently arranged components than those shown in FIG. 36. Additionally, or alternatively, a set of components (e.g., one or more components) of the device 3600 may perform one or more functions described as being performed by another set of components of the device 3600.

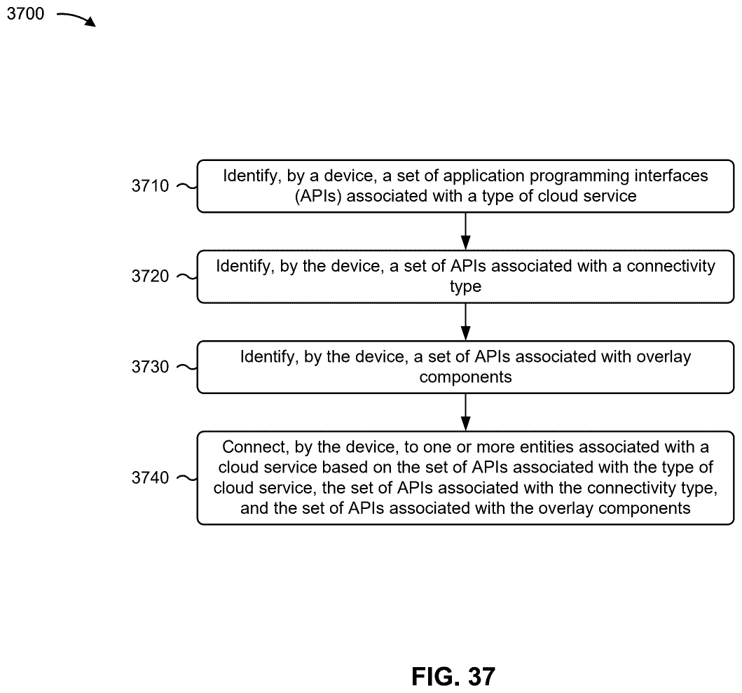

FIG. 37 is a flowchart of an example process 3700 associated with APIs associated with cloud services. In some implementations, one or more process blocks of FIG. 37 may be performed by a device (e.g., client device 102). In some implementations, one or more process blocks of FIG. 37 may be performed by another entity or a group of entities separate from or including the device. Additionally, or alternatively, one or more process blocks of FIG. 37 may be performed by one or more components of device 3500, such as processor 3520, memory 3530, input component 3540, output component 3550, and/or communication component 3560.

As shown in FIG. 37, process 3700 may include identifying, by the device, a set of APIs associated with a type of cloud service (block 3710). The type of cloud service may be a self-service, a co-managed service, or a fully-managed service. The device may identify the type of cloud service based on the set of APIs associated with the type of cloud service.

As shown in FIG. 37, process 3700 may include identifying, by the device, a set of APIs associated with a connectivity type (block 3720). The connectivity type may include a volume connectivity charged based on byte counts transmitted over a time interval. The volume connectivity may be associated with an SCI virtual GW and a PIP network. The device may identify the volume connectivity based on the set of APIs associated with the connectivity type. The connectivity type may include a bandwidth connectivity charged based on a connectivity bandwidth size. The bandwidth connectivity may be associated with an SDI connectivity cloud ENNI with a combination of carrier hotel and cloud operator, and a PIP network. The device may identify the bandwidth connectivity based on the set of APIs associated with the connectivity type.

As shown in FIG. 37, process 3700 may include identifying, by the device, a set of APIs associated with overlay components (block 3730). The overlay components may be associated with a mesh network that includes an RE, a CE, and a connectivity among CEs. The overlay components may be associated with a CE or an RE connectivity.

As shown in FIG. 37, process 3700 may include connecting, by the device, to one or more entities associated with a cloud service based on the set of APIs associated with the type of cloud service, the set of APIs associated with the connectivity type, and the set of APIs associated with the overlay components (block 3740). The device may connect to the one or more entities based on one or more requests or one or more responses that are supported by a combination of operational APIs and payload APIs. The payload APIs may include the set of APIs associated with the type of cloud service, the set of APIs associated with the connectivity type, and the set of APIs associated with the overlay components. The device may retrieve one or more of: configuration values, an operation state, or an administrative state of the one or more entities, wherein the one or more entities are associated with a service model and a topology.

Although FIG. 37 shows example blocks of process 3700, in some implementations, process 3700 may include additional blocks, fewer blocks, different blocks, or differently arranged blocks than those depicted in FIG. 37. Additionally, or alternatively, two or more of the blocks of process 3700 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
identifying, by a device, a set of application programming interfaces (APIs) associated with a type of cloud service;
identifying, by the device, a set of APIs associated with a connectivity type;
identifying, by the device, a set of APIs associated with overlay components; and
connecting, by the device, to one or more entities associated with a cloud service based on the set of APIs associated with the type of cloud service, the set of APIs associated with the connectivity type, and the set of APIs associated with the overlay components.

2. The method of claim 1, wherein the type of cloud service is a self-service, a co-managed service, or a fully-managed service, and further comprising:
identifying, by the device, the type of cloud service based on the set of APIs associated with the type of cloud service.

3. The method of claim 1, wherein the connectivity type includes a volume connectivity charged based on byte counts transmitted over a time interval, and wherein the volume connectivity is associated with a software cloud interconnect (SCI) virtual gateway (GW) and a private Internet Protocol (PIP) network, and further comprising:
identifying, by the device, the volume connectivity based on the set of APIs associated with the connectivity type.

4. The method of claim 1, wherein the connectivity type includes a bandwidth connectivity charged based on a connectivity bandwidth, and wherein the bandwidth connectivity is associated with a software defined interconnect (SDI) connectivity cloud external network-to-network interface (ENNI) with a cloud operator and a private Internet Protocol (PIP) network, and further comprising:
identifying, by the device, the bandwidth connectivity based on the set of APIs associated with the connectivity type.

5. The method of claim 1, wherein the overlay components are associated with a mesh network that includes a regional edge (RE), a consumer edge (CE), and a connectivity among CEs.

6. The method of claim 1, wherein the overlay components are associated with a consumer edge (CE) or a regional edge (RE) connectivity.

7. The method of claim 1, wherein connecting to the one or more entities is based on one or more requests or one or more responses that are supported by a combination of operational APIs and payload APIs, wherein the payload APIs include the set of APIs associated with the type of cloud service, the set of APIs associated with the connectivity type, and the set of APIs associated with the overlay components, and wherein the operational APIs are associated with one or more of: product qualification, quoting, ordering, cataloging, fault monitoring, performance management, service health, testing, dynamic service modification, or security.

8. The method of claim 1, further comprising:
retrieving, by the device, one or more of: configuration values, an operation state, or an administrative state of the one or more entities, wherein the one or more entities are associated with a service model and a topology.

9. A device, comprising:
one or more processors configured to:
identify a set of application programming interfaces (APIs) associated with a type of cloud service;
identify a set of APIs associated with a connectivity type;
identify a set of APIs associated with overlay components; and
connect to one or more entities associated with a cloud service based on the set of APIs associated with the type of cloud service, the set of APIs associated with the connectivity type, and the set of APIs associated with the overlay components.

10. The device of claim 9, wherein the type of cloud service is a self-service, a co-managed service, or a fully-managed service, and wherein the one or more processors are further configured to:
identify the type of cloud service based on the set of APIs associated with the type of cloud service.

11. The device of claim 9, wherein the connectivity type includes a volume connectivity charged based on byte counts transmitted over a time interval, wherein the volume connectivity is associated with a software cloud interconnect (SCI) virtual gateway (GW) and a private Internet Protocol (PIP) network, and wherein the one or more processors are further configured to:
identify the volume connectivity based on the set of APIs associated with the connectivity type.

12. The device of claim 9, wherein the connectivity type includes a bandwidth connectivity charged based on a connectivity bandwidth, wherein the bandwidth connectivity is associated with a software defined interconnect (SDI) connectivity cloud external network-to-network interface (ENNI) with a cloud operator and a private Internet Protocol (PIP) network, and wherein the one or more processors are further configured to:
identify the bandwidth connectivity based on the set of APIs associated with the connectivity type.

13. The device of claim 9, wherein the overlay components are associated with a mesh network that includes a regional edge (RE), a consumer edge (CE), and a connectivity among CEs.

14. The device of claim 9, wherein the overlay components are associated with a consumer edge (CE) or a regional edge (RE) connectivity.

15. The device of claim 9, wherein the one or more processors are configured to connect to the one or more entities based on one or more requests or one or more responses that are supported by a combination of operational APIs and payload APIs, wherein the payload APIs include the set of APIs associated with the type of cloud service, the set of APIs associated with the connectivity type, and the set of APIs associated with the overlay components, and wherein the operational APIs are associated with one or more of: product qualification, quoting, ordering, cataloging, fault monitoring, performance management, service health, testing, dynamic service modification, or security.

16. The device of claim 9, wherein the one or more processors are further configured to:
retrieve one or more of: configuration values, an operation state, or an administrative state of the one or more entities, wherein the one or more entities are associated with a service model and a topology.

17. A non-transitory computer-readable medium storing a set of instructions, the set of instructions comprising:
one or more instructions that, when executed by one or more processors of a device, cause the device to:
identify a set of application programming interfaces (APIs) associated with a type of cloud service;
identify a set of APIs associated with a connectivity type;
identify a set of APIs associated with overlay components; and
connect to one or more entities associated with a cloud service based on the set of APIs associated with the type of cloud service, the set of APIs associated with the connectivity type, and the set of APIs associated with the overlay components.

18. The non-transitory computer-readable medium of claim 17, wherein the type of cloud service is a self-service, a co-managed service, or a fully-managed service, and wherein the one or more instructions, when executed by the one or more processors of a device, further cause the device to:
identify the type of cloud service based on the set of APIs associated with the type of cloud service.

19. The non-transitory computer-readable medium of claim 17, wherein the connectivity type includes a volume connectivity charged based on byte counts transmitted over a time interval, wherein the volume connectivity is associated with a software cloud interconnect (SCI) virtual gateway (GW) and a private Internet Protocol (PIP) network, and wherein the one or more instructions, when executed by the one or more processors of a device, further cause the device to:
identify the volume connectivity based on the set of APIs associated with the connectivity type.

20. The non-transitory computer-readable medium of claim 17, wherein the connectivity type includes a bandwidth connectivity charged based on a connectivity bandwidth, wherein the bandwidth connectivity is associated with a software defined interconnect (SDI) connectivity cloud external network-to-network interface (ENNI) with a cloud operator and a private Internet Protocol (PIP) network, and wherein the one or more instructions, when executed by the one or more processors of a device, further cause the device to:
identify the bandwidth connectivity based on the set of APIs associated with the connectivity type.
